(19) United States
(12) Patent Application Publication
(10) Pub. No.: US 2009/0198520 A1
(43) Pub. Date: Aug. 6, 2009

(54) Method and System for Routing Orders and Results

(75) Inventor: Jose E. Piovanetti-Perez, San Juan, PR (US)

Correspondence Address: Jose E Piovanetti-Perez, MD, 339 Almacigo St., San Juan, PR, 00926, US

(73) Assignee: Dr. Jose E Piovanetti-Perez, San Juan, PR (US)

(21) Appl. No.: 12/363,784

(22) Filed: Feb. 1, 2009

Related U.S. Application Data
(60) Provisional application No. 61/026,375, filed on Feb. 5, 2008.

(51) Int. Cl. G06Q 50/00; G06Q 10/00; G06Q 30/00

(52) U.S. Cl. 705/3; 705/8; 705/2; 705/26

(57) ABSTRACT

The temporary medical orders and results transactions repository that intercepts Business-to-Business (B2B) electronic communications from Point “A” (source and/or creator) to Point “B” (electronic communication recipient, address, name and/or destination) to allows handling of outpatient medical-orders where Point “B” doesn't have to be defined at Point “A” (while the medical-order is being created); allowing creation of electronic orders at Point “A” without knowledge of where or who is Point “B” and delegating the designation of Point “B” to another party, other than the original medical-order creator. In this way, the choice of products and/or service providers is defined without medical order-creator intervention and/or influence; all WITHOUT the need of Unique IDs (UID, GUID or the like).

The repository intercepts orders to be temporarily saved in the repository, either by business-rule, lack of destination information, or orders sent to the repository as destination,.

Order-fulfillers “claim” (route to themselves, etc.) unclaimed orders, limited to their line-of-work, using patient and/or order-creator properties or parameters to identify and select the correct order based on search engine, common database modalities and master patient/person index technologies available freely, as open source, or a combination, and once orders have been delivered to the destination, orders are purged after a set of conditions, due dates or fulfillment indicators are reached.

### DESCRIPTION OF THE INVENTION

A “Temporary Orders and Results Transaction Repository” (TORTR, hereafter) allows any system and/or any healthcare stakeholder, in addition to electronic medical order message “originator(s)” (ex doctor, prescriber, nurses, etc.) decision-making capabilities within a B2B environment, to chose, define, modify and/or re-assign final electronic transmission “destination”, at any time; not forcing destination-determination to be a requisite of the orders-making and/or completion process prior to “sending” the electronic message outside the point-of-care (POC) setting. In essence, the TORTR extends the currently B2B-modeled medical “Orders and Results” systems offerings and implementations so that patients, or others with the patients consent, can have the “last-say” in determining the routing and/or final destination of electronic Orders and Results messages from Point A (origin) to Point B (destination); even long after an encounter between the patient and the “ordering” healthcare provider. The TORTR provides some level of Business-to-Consumer (B2C) empowerment to the B2B-model used in the emerging computerized Physician Order Entry (CPOE) systems arising in healthcare, the systems used for medical “Orders and Results” exchange, and which are based on Point A to Point B electronic transmissions; which as of this writing, it is being addressed by forcing “inpatient” Orders and Results systems to work in an “outpatient” environment.

The “ordering” healthcare provider's (as a mater of example, a prescriber in the case or ePrescribing) current decision-making capacity is maintained, but through TORTR, the provider (the electronic transaction originator) can delegate to others (preferably through patient explicit or implicit consent) the decision of who will be the recipient (Point B, receiver and/or destination) of a B2B transaction in healthcare without interference, influence and/or intervention from the medical order originator (a prescriber in ePrescribing, an ordering provider in eLabs, a consulting provider in the case of eConsults, amongst others.) One way to view the TORTR is that it allows patients to designate or choose where their “medical orders” arrive without having to define a destination when the order is being prepared; thus allowing patients to select healthcare products and/or services providers even if they initially ignore names and/or addresses of such “order fulfiller”. The TORTR can also be used to submit inquires to multiple “potential” Point B's for information (one example being that of an inquire about drug stock-availability, final pricing to the patient, amongst other questions) before selecting the a destination (Point B).

The TORTR can be “embedded” into Orders and Results-related or Orders and Results-based system (in which case it would be expected to be useful only to those with rights to access and use the Order's and Results system where the TORTR in embedded in.)

The TORTR can also be implemented as a “independent and interoperable service”, supporting numerous Orders and Results systems, CPRs, Electronic Health Records (EHR), specialized software with “ordering” capabilities, Computerized Physician Order Entry (CPOE) systems, or any other system, even of the same and/or districts “types” of medical orders (prescriptions, lab tests, consults, amongst others), therefore benefiting a much broader audience (number of HIT-system providers, healthcare providers, patients, and so on.)

The TORTR is architected to use the schemas used by de-facto and de-jeure healthcare EDI standard and information models, therefore it (a) is NOT limited to a particular kind of electronic medical order such as ePrescribing, but rather any electronic medical Order and Result situation (ePrescribing, eLabs, eConsult, eReferrals, eAppointments, eImaging, and others), (b) could receive medical orders (ex. prescriptions, clinical laboratory tests requests, etc.) for safekeeping and handling from any interoperable healthcare information system that adopts standards-based Orders and Results transactions (ex. HL7, NCPDP, ANSI, XML, etc.) such as interoperable, certified and/or compliant health information technology (HIT) and/or EHR system, (c) supports emerging personal health record (PHR) systems that comply with interoperability standards; amongst other electronic orders and results possibilities.

The “type” of medical orders (medication prescription, clinical lab test request, imaging diagnostic study request, etc) is recognized and the TORTR acts according to what is expected for each type of medical order, in the normal B2B transmission of such medical orders, providing the benefits enumerated and mentioned before (amongst others) but as they apply to each healthcare products and/or service environment; for example, in ePrescribing works as required in managing destination determination of electronic prescriptions, in eLabs it works as required to manage destination determination of eLab requests, and so on.

The TORTR does not modify the usual B2B “Point A to Point B” approach to transaction sending-and-receiving, but rather, by “plugging” into it, extends B2B. It allows better control over the routing of electronic transactions; like (a) having B2B that allows selection of Point B after Point A has culminated its responsibilities, created and “submitted” the transaction, and (b) the selection of Point B (the transaction's final destination) can be performed by individuals (preferably through patient consent) different from those that originated the transaction at Point A (transaction origin and/or creator). Once Point B is defined, the transaction continues the B2B customary trail (electronic transfer means, form, architecture, model, exchange-type, network and/or infrastructure), standards and protocols as usual until it reaches its destination (as if Point B had been defined by the ordering-provider in the first place).

One example of how the TORTR extends traditional views of B2B is, if for any reason the transaction arrives at a Point B (destination), and it is determined that the intent and/or purpose of the transaction cannot be fulfilled (ex. an electronic prescription cannot be dispensed since the pharmacy is out-of-stock), the transaction can be “returned” to the TORTR so a new Point B (destination) can be defined. As an example, one pharmacy may “claim” (not to be confused with claims-for-patent) an electronic prescription, later to find that it cannot fulfill the order for lack-of-stock of the ordered drug; the pharmacy may decide to “return” the electronic prescription to the TORTR so another drug-store may “claim” the electronic prescription and dispense the ordered medications. This capability allows orders to be routed and re-routed as needed in a healthcare-environment comprised of independent, private, products and/or services providers physically distant, in a free-market and value-driven environment.

Without the TORTR, and based on the current Orders and Results models being implemented nowadays, we are implementing systems limited to intra-institutional information sharing and forcing the implementation of an “inpatient vision” into the “outpatient scenario”. As a matter of example, as defined by the MMA, there is no way pharmacies can transfer electronic prescriptions from one pharmacy to another pharmacy in the event the first pharmacy cannot fulfill the order; so returning “claimed” orders to the TORTR allows transfers to occur, whereas without the TORTR patients may be held hostage to a particular pharmacy(ies) until his/her ordered drug are back in-stock; a situation that will be then attributed as one of the many tradeoffs in order to attain ePrescribing.

The TORTR assures that the patient's decision-making rights are preserved in a healthcare-environment where transactions need to be routed and re-routed to physically-distant providers, in independently-operating locations, amongst a free-market, value-driven and competitive healthcare environment; not a centralized and/or government-controlled model. The TORTR also allows for more than one recipient to fulfill an “order”; for example, multiple pharmacies dispensing partial amounts of a prescription depending on their inventory stock, multiple clinical labs performing different tests or components, and so on; all without changing the current B2B model and/or implementations made to date.

The TORTR can also be used to “multicast inquires” (inquires for information sent to multiple potential destinations simultaneously) so that the most effective and/or convenient Point B (transaction destination) can be selected.

### BACKGROUND OF THE INVENTION

In the early 1991, the Institute of Medicine, part of the National Academy of Sciences, published the original version of a book entitled “The Computer-Based Patient Record: An Essential Technology for Health Care”. This publication garnered widespread attention, set a target for widespread adoption or Computer-based patient Records (CPRs) within ten (10) years and began the wave of attention towards adoption of health information technology (HIT) to manage clinical information in the U.S.A.

The publication was revised again in 1997 to include social and technical advances that cropped up exponentially during the six (6) years after the original publication, and closely coincided with a halfway-point of the target set originally in 1991. Some of these advances included the approximate 8-fold increase in power and capacity of personal computers, improvements in peripheral devices with the result of making powerful workstations more affordable. The dramatic strides in computer technology where accompanied by the massive growth of the Internet, as well as of local and regional networks that linked communities, schools, health care providers, and individuals to information resources around the world.

As people continued to become more active “consumers” of health care and assume greater responsibility for managing their own health, and as information technology became available in more homes, individuals increasingly used the emerging technologies at hand to search through the health literature, communicate with their health care professionals, access data on their health care history, track the costs and value of the services they receive, diagnose acute conditions, and manage chronic conditions. These and other demands brought to the attention the reality that healthcare is a complex environment, that works as “islands of information” and that needed to be transformed into an integrated delivery system; where all health stakeholders (anyone related to health care, including but not limited to, providers, patients, payers, public health agencies, etc.) all collaborated for the benefit of all. As one example, using CPRs and emerging communications technologies, patients with chronic conditions could share monitoring information results electronically with their health care providers creating a more cost-effective health system. Doctors could order tests or consults, or request that patients visited them when monitoring parameters (blood sugar levels, spirometry readings for asthmatics, weight gain in patent with congestive heart diseases, etc.) alerted them of possible worsening before the situations became out of control.

For example, the Preface of the original 1991 release of the aforementioned publication included a paragraph that we site herein; “The activities of several other groups also lend support to the move toward widespread implementation of computer-based records. The General Accounting Office recently released a forward-looking report on the potential benefits of patient record automation. Several Institute of Medicine reports published over the last two years cite the need for improved patient data collection to support quality assurance, utilization management, and effectiveness research. The National Science Foundation recently issued a report on the benefits of a national system for very high-speed data communication, including health data. Finally, the National Research Council's recently released report on safe computing in the information age outlines problems and opportunities in computer security.”

But establishing these communications between health care stakeholders required entities or services that could serve as neutral third-parties helping route and exchange information amongst all health care stakeholders; otherwise everybody would need to establish communications and “trading partner agreements” (TPA) with everybody else with whom they could exchange information electronically. These gave rise to what was then termed “Community Health information Networks” (CHINs). The term was conceived as a reflection of how citizens of the late 20^{th} century acquired health care and managed their clinical conditions; “Community” as representing clustered groups of people or geographically isolated individuals brought together by a shared need, “Health” as the shared need of the clustered groups of geographically isolated people, “Information” as a depiction of the many sources and forms of knowledge (health states, clinical knowledge, charges for services, advice, etc.), and “Network” since it evokes the image and sense of linkages, communication pathways and organizational alliances and/or partnerships.

The problem with these CHIN's was that the vast majority where set-up by idealists, in good faith, based on grants and philanthropy money; in a capitalist environment that required that such operations be self-sustaining at best. Therefore, long-term viability of CHINs was not envisioned and steps weren't taken to make CHINS self-sustaining or generate added value that overshadowed any costs. Additionally, there was no National nor State backing of these efforts since they where seen as “scientific” or “health” initiatives between healthcare participants and computer systems developers that supported health care; not as a National priority in transforming health care, controlling its ever-increasing costs without evidence of return on investment, etc.

In 2004, under president George W. Bush, following the guidance of numerous studies demonstrating the benefits of electronic health information and the “sharing” of such information amongst stakeholders, the U.S. Federal Government, under Executive Order #13335 embarked in a movement that called for “widespread adoption of interoperable EHRs within ten (10) years”. In order for people to take this initiative seriously, the Executive Order established a new sub-cabinet level position of “National Coordinator for Health Information Technology”. The Order directed the National Coordinator to produce a report on the development and implementation of a Strategic-Plan to guide the nationwide-implementation of interoperable health information technology (HIT) and the National Coordinator was (at the time) charged with four (4) primary responsibilities:
1. Serve as the senior advisor to the Secretary of health and Human Services (HHS) and the President of the U.S. on all HIT programs and initiatives;
2. Develop and maintain a Strategic Plan to guide the nationwide implementation of interoperable EHRs in the public and private healthcare sectors;
3. Coordinate spending of approximately $4 billion for HIT programs and initiatives across the federal enterprise;
4. Coordinate all outreach activities to private industry and serve as the catalyst for healthcare industry change

On Jul. 21, 2004, the Office of the National Coordinator for Health Information Technology (ONCHIT), created by the aforementioned Executive Order published the report “Health IT Strategic Framework.” The report outlined a framework for a dynamic and iterative strategic-plan, implemented in coordination with the private0sector, toward the creation of the “National Health Information Infrastructure” (NHII; later referred to as a “National Health Information Network” or “NHIN”). The Framework acknowledged that:
Preventable medical errors and treatment variations had gained nationwide attention.
Clinicians may not know the latest treatment options
Practices vary across clinicians and regions.
Consumers want to have choices in treatment; and when they do, they want to have the information they need to make decisions about their own care.
Concerns about the privacy and security of medical information remain high.
Public-health monitoring, bio-terror surveillance, research and quality monitoring require data that depends on widespread adoption of interoperable and standards-complaint Health Information Technology (HIT).

The framework envisioned a health care industry . . . :
that is consumer-centric and information-rich,
in which medical information follows the consumer (patient), with tools guide medical decisions, and where . . .
   clinicians have access to a patient's complete treatment history; medical records, medication history, laboratory results, radiographs (among other information).
   clinicians order medications with systems that eliminate handwriting-errors and automatically check for harmful interactions with other drugs, allergies, diagnoses, etc.
   prescriptions are checked against a plan's “formulary” (list of medications covered for a patient according to his/her health insurance), and out-of-pocket costs of the prescribed drug can be compared with alternative treatments . . . .
   clinicians receive reminders (alerts) about treatment procedures and guidelines . . . .

In essence, a different way of delivering health care than what exists as of this writing, but one that many envisioned even before the early 1990's. A new way that result in fewer medical errors, fewer unnecessary treatments and/or services, fewer variations in care to ultimately improve care. A system centered on the patient and information delivered electronically, where clinicians spend more time on patient-care and employers gain from related productivities and benefits.

Finally, the ONCHIT report identifies four (4) “goals” to achieve the NHIN:
1. Inform Clinical Practice
2. Interconnect Clinicians
3. Personalize Care
4. Improve Population Health

Contrary to the 1990's, this time the Federal Government decided to “lead-by-example”, directing its health care operations such as the VA, DoD, SAMHSA, IHS, Public Health Service, etc., to begin adopting HIT and sharing health data as quickly as possible, and provide funding and entice the private health sector towards HIT adoption through incentives arising from its health care related services and/or agencies. Additionally, the NHII/NHIN was recognized as comprised of smaller/regional health information exchange operations that when interconnected would establish the end-goal of the NHIN; much like the Internet and the role of Internet Service Providers (ISPs). These regional organizations, originally identified as “Local Health Information Networks” where later renamed “Regional Health Information Networks” (RHIOs) and are essentially what the CHINs of the past wanted to accomplish; but set up by the private sector, with government and wide health-industry support, and having a sustainable business-model behind it (regardless if they where set as utilities, non-profits, for-profits, etc.), they had to be self-sustaining in the end and for the long run.

Nonetheless, many of the same hurdles that where to be surmounted during the CHIN era have come back to bite those who attempt to implement health information exchange (HIE). When performing HIE, one has to assume that ALL stakeholders are connected to their respective HIE infrastructure, at all times (24 hours a day, 7 days a week, 365 days a year and without or minimal interruptions.) But more pressing is the fact that stakeholders, particularly health care professionals, would have to know exactly, or determine at the point of care (POC), the address and/or recipient of the health information to be exchanged electronically for health products and/or services provided by other health care providers. This, for example, not only demands that providers know the purveyor of products and/or services for each individual patient, but could limit or even eliminate the decision-making capability currently available to patients to chose the place and/or purveyor of health products and/or services.

While CHIN, RHIO and NHIN where debated, most medical doctors dedicated and/or specializing in medical informatics debated the order in which HIT should be brought about in order to transform healthcare from a paper based sector to a technology-based system. Registration was a natural first stem; getting patient's names addresses, health insurance information, prior diagnoses, allergies (if available) and other demographic information never much debated as the starting point. Thereafter, consensus arose that Computerized Physician Order Entry (CPOE) was a next step since achieving HIT adoption encompassed a lot of the services and/or procedures carried our in diagnosing and treating patients; leaving clinical documentation such as progress notes and other documentation for last; since retaining the semantics of free-text and encoding information so that as the meaning of a healthcare professional's documentation is preserved without any doubt and without misinterpretation still required a lot of work and medical language processing research.

CPOE, as the term implies, is anything that has to with a medical and/or health care “Order” and the “Result” (if any) obtained from an “Order”. A medical “order” is not a mandate to a patient but rather a request that is performed by a licensed health care provider, on behalf of a patient, so that a product and/or service be provided to a patient to attend a patient's health problem(s) (try to surmount, improve, alleviate, resolve or even diagnose his/her problem).

“Orders” include, amongst many other things, prescriptions (an “order” to take a medication), clinical laboratory tests (an “order” to have clinical lab test(s) performed to gather information about the human body's metabolic functioning), referrals (an “order” to visit another doctor, specialist, sub-specialist or second opinion), a referral to a nutritionist (an “order” to visit a person specialized in nutritional issues), a definition of a particular diet (and “order” to be followed by the kitchen or food delivery service to provide nutrients that conform to particular regimes), and many other health care products and/or services requests.

“Results” are the information returned back from most “orders”, for example, in the case of medication prescriptions, that the medications where dispensed and/or that the patient is taking the medication as instructed; in the case of clinical laboratory tests, the results of the requested tests; in the case of imaging studies (radiology, magnetic resonance, computed tomography positron emitting tomography, etc.), the interpretation of the radiologist and/or nuclear medicine specialists (or others) or the observations of the procedures performed compared to the medical history; in the case of a nutritionist, the diet recommendations for the patient; and so on depending on what is “ordered” and if such “order” is usually accompanied by a “result” (or reply).

For example, clinical laboratory tests orders are usually responded with the tests results, and a referral is usually responded with the specialists recommendations, and so on. Therefore, CPOE is at the forefront of HIT or electronic health record (EHR) implementations everywhere.

Prescription Example

Arising from the Medicare Modernization Act of 2003 (MMA), patients are given the option (unless future legislation or rulemaking changes this) to have their prescription (an “order” for receiving some medications) performed electronically or in the current form (a piece of paper written by hand in a prescription-pad).

Current Paper-based (“Pen and Paper”) Prescriptions

When patients are given their prescription on a piece of paper, it is up to the patient to decide the pharmacy (a health products and/or services provider) where he/she will take the prescription so it is dispensed; it is up to the patient to decide who and/or what pharmacy will serve the patient. Nonetheless, the patient has to wait until the pharmacy attendant verifies the patient eligibility, co-pay information, not to mention the prescriber's handwriting before dispensing. In the event there is an eligibility, coverage and/or other doubt, either the pharmacy attendant (pharmacist or pharmacy technician, or other person) has to either call the prescriber for clarification, contact the payer for approval, or in some cases the patient is forced to return to the prescriber for a new prescription.

Current Electronic Prescribing

Electronic Prescribing (ePrescribing) was envisioned and developed following traditional Business-to-Business (B2B) model, the prescriber (a healthcare provider licensed to prescribe medications) has access to patient eligibility information and thus can prescribe based on what the patient's insurance covers. Optionally, the prescriber is alerted about potential interactions against other drugs the patient might be taking alerted based on the patient's prior medical history (diagnoses, allergies, foods, etc.). Once these optional concerns are overcome, the prescriber finalizes the electronic prescription (ePrescription) by identifying and/or choosing a destination (recipient for the electronic message/transaction/prescription) and directs the electronic message to that destination (a pharmacy, in this example) where the patient has to go to pick-up his/her medications. So, ePrescribing alleviates a lot of eligibility, potential adverse drug events and/or effects, but requires that the recipient of the electronic prescription (the pharmacy) to be chosen (hopefully with the patient's consent) at the time the prescription be created.

More so, ePrescribing systems have to be “certified” by the “ePrescribing networks” and payers to whom they connect to, and these networks require that prescribers select a pharmacy (from a list or pharmacies provided by such networks) so that when and electronic prescription is submitted the network it can be routed directly to the recipient (a pharmacy). Therefore, ePrescribing having been modeled following a strict B2B approach, limits or eliminates the decision-making freedom currently enjoyed by patients nowadays when they can chose the place and/or purveyor of health products and/or services; the current ePrescribing B2B-approach directs us towards a practice of forcing transactions from Point A to Point B without dilation and without accommodating for alternative decision-making of Point Bs outside the confines of the point-of-care (POC); hence the destination pharmacy HAS TO BE decided and DEFINED to sign and submit the electronic prescription. It eliminates the social interactions and behaviors that patients a accustomed-to in exchange of a technological remodeling of delivering a prescription from prescriber-to-pharmacy; a very “high tech” thing that lacks the “high touch” component humans come to appreciate as social-beings. It also eliminates the possibility of contacting various pharmacies to inquire medication stock-availability, final-cost to consumer, etc.

The patients prescription arriving electronically from the prescriber, most likely will be re-subjected to eligibility verifications, co-pay information, drug interactions, legibility verification (not the prescriber's handwriting) once the prescription arrives at the pharmacy (as part of the dispensing process and as part of the professional duties of pharmacists). In the event a, and/or the, drug is not available, there are several possibilities; either (1) to ask the prescriber to create another prescription (either using the original as template), canceling the ongoing and create a new prescription and routing the new prescription to a different pharmacy, (2) the pharmacy that doesn't have a prescribed drug routes the prescription to another pharmacy who has the drug (which is common knowledge is a practice that rarely occurs due to the competitive environment of pharmacies), or (3) the patient is asked to come “at a later time” back to the pharmacy (so supplies can be sought and/or inventory supplied); amongst other schemes. In the mean time, the patient waits for his prescription to be dispensed, hence, the last step in the prescription-dispensing saga is merely transformed by ePrescribing and/or remains unaltered and could possibly become more disadvantageous to the patient as he/she is held “hostage” to what the industry calls the “limits of the new ePrescribing model”.

Prescribing problems that without ePrescribing usually arise at the beginning of the prescribing-practiced are transformed to new methods of patient retention and market-competition at the end of the prescription healthcare products and/or service realm. Basically, ePrescribing is B2B implemented in the prescribing process so and everything has to go from Point A to Point B and Point B has to be defined at the POC, supposedly in “agreement between patient and prescriber”.

Electronic Clinical Labs Example

The federal government has not yet established a model for electronic clinical laboratory tests (eLabs) orders and clinical laboratory tests results electronic transmission. Nevertheless, organizations created by the federal government and with extensive private sector participation have already (as of this writing) begun identifying the standards and model that should be adopted for these kinds or “Orders and Results”.

At the same time, as of this writing, large clinical laboratory tests companies (several of which exists in the U.S.) have set up their own internet-connected “portals” so that clinicians and/or organizations requesting clinical laboratory tests can send them the “order” electronically and the “results” can be returned to the original healthcare requestor electronically. This, contrary to ePrescribing, complicates things as each clinical laboratory company has created its own “network”, via their “portals”, hence there are many networks to take into account and standardizing will take time. Nevertheless, standards to electronics transmission of messages, containing a “medical order” as well as the “results” have been more or less accepted and most stakeholders are adopting the same protocols and standards (mainly HL7, ANSI, XML, LOINC and SNOMED; amongst a plurality of others).

However, in the case of clinical laboratory tests, due to the lack of a formal mandate (at least at the U.S. Federal Government level) as of this writing, has driven the medical informatics community to accommodate standards “implementation” (one example being, how to use HL7 in some case scenarios.) Not withstanding which standard or method arises as dominant, preferred or mandated, the end model will be one that mimic ePrescribing (following B2B customs) in that a clinician will “order” a clinical laboratory test and once the patient and test are defined, the recipient of the “order” needs will also be selected by the clinician; something that limits or eliminates the decision-making freedom currently enjoyed by patients; since nowadays they can chose the place and/or purveyor of health products and/or services. The B2B approach directs us towards a practice of forcing transactions from Point A to Point B without dilation and without a accommodating for alternative decision-making of Point B's outside the confines of the POC.

Electronic Imaging Diagnostic Tests (Radiology, Computer Tomography (CT), Magnetic Resonance Imaging (MRI), Positron Emission Tomography (PET), Sonography/Echography, Nuclear Medicine, etc.) Example

The Executive Order #13335 signed by President George W Bush mentions having radiology tests and results ordered and replied over electronic means as one of the examples that the nation should follow. Nonetheless, as of this writing the federal government has not established a model for electronic imaging studies (X-Rays, CT-Scans, MRIs, PET-Scans, Nuclear Medicine exams, Densitometries, Sonography, etc.) Orders and Results. However, the U.S. Federal Government has been very clear in the use of DICOM as “image format”, and HL7 and other HIT standards as Electronic Data Interchange (EDI) protocols amongst other examples of its “leading-by-example” implementations in its federal health-related programs (as mentioned beforehand).

As of this writing, there are few large radiology, medical imaging, nuclear medicine and/or other “imaging” (referred to as “eImaging” hereafter) companies nationwide (although the trend has begun to take place but its success is still to be determined). In the mean time, as with eLabs, each medical imaging center accepting electronic “orders” from the outside has created its own “portal”. Although most rely on DICOM as “image format” to return images to ordering providers, there are a myriad of “portal implementations” for placing “orders” and obtaining “results” from medical imaging centers/providers (as with large clinical laboratory tests companies); hence much more diversity to be addressed in the future.

So, despite that most electronically accessible imaging centers are accepting standards-based “orders”, and delivering resulting images in DICOM image format (and sometimes interpretations in HL7 formatted results), the fact that the ordering provider has to define the entity that will receive the imaging study “order”, and since each imaging center might be accessible only through their own and unique “portal”, complicates things as each center has created basically created its own “network”, hence there are many networks to take into account and standardizing will take more time to be accomplished.

However, not withstanding which standard and model dominates eImaging, the end will be one that will mimic ePrescribing, and possibly eLabs, to some extent; that is, a clinician's “order” for a “imaging diagnostic test” is defined, and the ordering provider will have to define the recipient of the “order” (a.k.a. “Point B”); something that limits or eliminates the decision-making freedom currently enjoyed by patients, since nowadays they can chose the place and/or purveyor of health products and/or services. The B2B approach directs us towards a practice of forcing transactions from Point A to Point B without dilation and without a accommodating for alternative decision-making of Point B's outside the confines of the POC.

Referrals and Results (Specialists and/or sub-Specialists, Nutritionists, Skilled Nursing, Long-Term Care, etc.) Example

It has been extensively discussed in medical informatics circles that once ePrescribing, eLabs and eImaging are addressed, the next CPOE issue to be attended should be

Referrals and/or Consults (hereafter referred to as “eReferrals” and/or “eConsults”).

These activities are also part of the overall “Orders and Results” realm in healthcare, but in this case, one healthcare provider (usually but not limited to a Primary Care Provider or “PCP”) will essentially ask for, “order”, an appointment for one of his/her patients, so that the patient be seen and/or evaluated by a subject matter expert, specialist and/or sub-specialists (an eReferral or eConsult “order”) and will receive treatment recommendations (“results”) to follow to see if such recommendations improve the patients condition.

In eReferrals and/or eConsults healthcare providers communicate with others, including other allied healthcare care providers, “alternative-medicine” specialists, amongst others, for an exchange of knowledge and treatment guidance.

As of this writing, the U.S. Federal Government has not issued comments on eReferrals and/or eConsults, but it is well known, that being part of the overall scope of medical “Orders and Results”, it will eventually be addressed by HIT, that standards for such electronic information exchange exist (including HL7 ), and that such standards will be applied for such purposes. Ultimately, many politicians have used this issue as examples of how inefficient the healthcare system is in the U.S.A; thus we know it will be address sooner rather than later.

However, not withstanding how it is implemented, as with any other Orders and Results implementation previously discussed (ePrescribing, eLabs, eImaging, etc.), a clinician's referral or consultation “order” will have to have a recipient of the “order” (a.k.a. “Point B”); something that limits or eliminates the decision-making freedom currently enjoyed by patients, since nowadays they can chose the place and/or purveyor of health products and/or services. The B2B approach directs us towards a practice of forcing transactions from Point A to Point B without dilation and without a accommodating for alternative decision-making of Point B's outside the confines of the POC.

Electronic Appointment Requests Example

Appointments could be viewed in diverse ways; either as a “scheduling” issue, or as an eReferral or eConsult, since the appointment could en up with a “result” returned to a Primary Care Provider (PCP). Notwithstanding how we view appointments, it all comes down to ordering (or requesting) that the patient be assigned to a time-slot available with a health care provider; and a healthcare worker, or the patient itself, can place the “order”. If we see what has happened elsewhere thanks to the Internet we can electronically book a hotel room in Tahiti; hence we are essentially “ordering” and if there's a vacancy and we get a confirmation (a “result”) or other kind of response (“result”) from our reservation.

In healthcare ordering an appointment, at this point in time, requires that we call or contact the desired healthcare provider to discuss and be assigned to a mutually convenient time-slot.

However, some providers and organizations have begun to implement electronic appointments, (eAppointments) by creating their own “portals” where we can see time-slots that are available and “order” (request) that a particular time-slot, if available or vacant, be assigned to us; all through electronic messaging. Unfortunately, as with other electronic B2B implementations without explicit or relying on vendor-specific guidance ultimately results in an unimaginable level of diversity to be addressed. In other words, the fact that each provider and/or organization makes electronic appointments accessible through “their own and unique portal”, complicates things as each entity has created basically created its own “network”, hence there are many networks to take into account and standardizing will take more time to be accomplished.

Also, electronic appointments requires that we know the healthcare provider with whom we want to make an appointment, and if we are not sure of his/her name and/or location, defining whose schedule we are going to view, or to whom we are going send an appointment request to, becomes impossible; similar if not equal to the current non-electronic appointment process.

PCPs and managed care plans have a lot to gain since these have to provide health maintenance services that in most instances require a visit to a specialist and/or sub-specialist for routine exams; for example, retinal exams by an ophthalmologists for diabetics, cardiologists evaluations for patients with chronic heart disease, amongst others. eAppointments, which in essence is a variation of eReferrals and/or eConsults, would expedite and simplify the process dramatically; but it could limit or eliminate the decision-making freedom currently enjoyed by patients, since nowadays they can chose the place and/or purveyor of health products and/or services. The B2B approach directs us towards a practice of forcing transactions from Point A to Point B without dilation and without a accommodating for alternative decision-making of Point B's outside the confines of the POC.

### TECHNICAL FIELD

The invention extends the B2B nature of current medical “Orders and Results”-based systems, technologies and capabilities being adopted gradually by the healthcare sector by allowing transactions to be “submitted” for delivery without a destination, and thus “intercepted” and/or “captured” by, or “sent” to, a “Temporary Orders and Results Transaction Repository” (TORTR) until the transaction's final destination and/or recipient can be identified, defined and/or accorded (primarily through the patient's consent) and without holding the electronic transaction creator/originator locked-in by the ordering process by having to determine the electronic-transactions final “destination”, particularly when such destination is (a) unknown, (b) can be determined at a later time, (c) can be determined by another party, (d) the transaction has to be re-routed from one destination to another (such as in “forwarding” an email message, for example), (e) the transaction destination depends upon an inquiry and/or prior research, amongst a plurality of other situations and/or other conditions.

### DESCRIPTION OF THE RELATED ART

The US healthcare sector is adopting HIT thanks to federal initiatives making the need for HIT very visible, providing grants and other economic stimulus for interoperable HIT adoption, and having taken the position of “leading by example” in all federal health-related agencies and/or services; not to mention and regulations that require that some HIT be implemented in order to participate in the healthcare sector. For example, HIPAA mandated the use of certain electronic transaction standards if some common healthcare-sector business transactions where conducted electronically. Eventually this lead to the fact that in a matter of years almost every healthcare product and/or service provider has had to adopt these, despite that they where “not mandatory” since the market reaped benefits that induced it to fully embrace what HIPAA mandated. Then came a national HIT initiative that is in everybody's mind continually, in the news, in politician speeches, in healthcare providers radars. Interoperable HIT is inevitable because its benefits outweigh its costs and unknowns.

The route taken by the U.S. Federal government is that to entice people to begin utilizing HIT, it will begin with the most prominent part of electronic “Orders and Results”, beginning with electronic prescribing (ePrescribing), and its said to be followed by electronic clinical laboratories, radiology/imaging, and so on. The reason is simple, to achieve full HIT adoption we need to take small steps, learn from prior mistakes, then take further steps, until eventually we arrive at a goal; the “all-or-nothing” approach to HIT-implementation has proven again-and-again to be a recipe for failure.

In the mean time, current Orders and Results related chores, specially in outpatient settings where HIT adoption is at its lowest, are performed using paper forms, taken from one place to another by the patient, and results are returned in other paper forms carried back to the original “Order” requestor by the patient.

Looking at prescribing medications between a prescriber, a patient, and the dispenser (usually a pharmacist), most of today's medication prescriptions are written by hand by a prescriber in a piece of paper (usually using a “prescription pad”) and handed to the patient; the patient goes to his/her selected pharmacy and handles the prescription to the pharmacist or appropriate attendant. The pharmacists interprets the prescriber's handwriting and enters the information into a Pharmacy Information System (PIS) to check the patients eligibility (with the insurance company's Pharmacy Benefit Manager or PBM), gets the patient's applicable “formulary” (the list of medications that he/she that are covered and/or that the patient has rights to under his/her insurance premium), checks for possible interactions the patient may encounter and should be made aware of, and if everything is okay, dispenses the medications to the patient. If problems of any kind arise, such as (a) the pharmacist cannot understand the prescriber's handwriting (which is very common), (b) the patient might not be eligible for such medication and might have to pay it out-of-pocket, (c) the drug might need a prior authorization from the insurance company, (d) the drug cannot be prescribed unless other drugs are tried first (a.k.a. “step therapy”), or other possible reason, the patient might need to return to the prescriber for a new an/or corrected prescription. To alleviate these problems, the U.S. Federal Government, through the Medicare Modernization Act of 2003, created an electronic prescribing program available to all “Medicare Eligible” individuals and that required that if prescriptions are done electronically, they have to comply with a set of standards set forth by the U.S. Department of Health and Human Services (HHS).

As with HIPAA, the electronic prescribing program is not “mandatory”, but the market made several pilots, has seen and reaped its benefits, and is enticing the health sector to adopt it; regardless of Medicare.

The current electronic prescribing (ePrescribing) model follows a B2B approach in that the partiers involved in drug prescribing, dispensing and payment connect to each other to provide information that was never available to the prescriber at the point-of-care (POC). This means that the prescriber can verify eligibility, formulary, covered drugs, and prescribe in accordance to what the patient's health insurance coverage makes available to the patient. The prescriber can also see alternatives, co-pay information, and even information and alerts on possible interactions with other drugs, allergies, diagnoses, etc. However, the model requires that the prescriber define a pharmacy that will receive the electronic prescription; this opens the door for “directing” patients, and/or sending prescriptions to the wrong pharmacy, or problems if the patient doesn't know or remember his preferred pharmacy's name and/or address, and so on. This worries healthcare stakeholders in differing ways; (a) prescribers might submit prescriptions to the wrong pharmacy and cause problems to the patient; (b) patient's might be “enticed” to use a particular pharmacy reducing their “right to choose” and/or freedom they've come to appreciate and protect wholeheartedly and/or might have a legal right to; (c) small neighborhood-pharmacies might see their business volume drop due to any number of incentives that might “direct” patients to other venues; (d) practices might incur in law violations (such as STARK, self-referrals, etc.) unknowingly; amongst others.

The same is being observed in ongoing pilots for electronic clinical laboratory test orders. In these cases, clinical laboratory tests are being routed mainly to the major clinical laboratory tests powerhouses, affecting the neighborhood clinical laboratories that lack the fiscal resources to create Internet accessible and/or eBusiness portals to attract patient tests/orders.

Several diagnostic-tests imaging centers have created web-accessible portals to receive diagnostic-tests orders and have seen these implementations create friction with their peers and/or colleagues; some complaints include (a) the perception of unethical business practices, (b) transforming the code-of-conduct of doctors into a market-like environment where marketing and not patient-trust and doctor-patient relationships “directs” the patients decision making process, and so on. Additionally, in many have reported less than expected adoption and/or use of such investments.

The same is to be expected when Referrals and Consults are made available electronically; a primary care provider (PCP) might want his patient to visit a certain specialist and route the consultation or referral order to such specialist, which might not be what the specialist that the patient feels comfortable with if there are others to choose from, and so on.

Consequently, it would be desirable that an option be provided so that “medical orders” (prescriptions, clinical laboratory tests, referrals, consultations, dietician consultation, durable medical equipment (wheelchairs, special beds, scooters, oxygen concentrators, etc.), and/or any other medical products and/or services requests) and even some appointments, can be issued electronically without having to define the destination of the electronic order/message; giving the patient the chance to decide where to fulfill his/her medical order; hence expanding B2B from simply a Point A to Point B electronic transmission operation, and allowing that Point B be defined AFTER an electronic message is created and “submitted” for fulfillment; Point B can be defined by the patient; Point B can be changed at one Point B to another Point B for reasons that might benefit the patient and protects the patients rights, amongst a plurality of other scenarios.

These capabilities address many healthcare stakeholders concerns, amongst them; (a) health care providers might feel relief that pharmacy, clinical lab, referrals, consultations, or other “order” destination-selection can be postponed or delegated and hence not be accidentally assigned to the wrong destination; (b) neighborhood pharmacies may not see ePrescribing as threatening their patient clientele and/or volume, (c) neighborhood clinical laboratories would feel the same as neighborhood pharmacies but as it relates to their line-of-work; (d) patient's might have the opportunity to research and do fact-finding before they decide who of where “medical orders: related to them go; (e) via interoperable Personal Health Records (PHR) patient themselves might see and route “unclaimed” or “Order-Undergoing-Inquiry-Before-Commit” (OUIBC) orders to specific order fulfillers; just to name a few possibilities, scenarios and/or cases here.

### SUMMARY OF THE INVENTION

Electronic orders and/or messages should be electronically addressed to a particular type of healthcare provider (ex. another doctor, pharmacist, clinical laboratory, diagnostic-procedure provider such as radiology, CT-CAN, MRI, nuclear medicine, pathologist or other practice and/or center, etc.). However, sometimes the electronic address of a recipient is unknown and/or the selection of such destination should be delegated to other healthcare stakeholders so they find and define the electronic address of the final destination of the transaction. The current Orders and Results model implemented in the U.S. outpatient healthcare sector forces providers to select a destination, otherwise their medical order cannot be signed and submitted and taken out of their work-queue.

A healthcare standards-based healthcare-TORTR, which can be accessed by other healthcare providers and even patients (after appropriate authentication and/or tools are made available to them), using methods and practices compliant with applicable law and regulations, would allow providers to create orders, sign and submit these without having to identify the order's destination, while having the order removed from the providers work-queue or pending-work list by sending orders to the TORTR; knowingly, automatically and/or based on certain rules. Thereafter, other health care providers or ancillary professionals can search the TORTR, limited to their line-of-work, to find, “claim” and/or reposition the order into the route the medical order usually takes to arrive at the destination of the patient's choosing or where the patient it located, using the customary and/or current electronic transaction handling infrastructure and/or the Internet; as if the order destination had been defined when the order was created by the ordering provider. Again, once an order is “claimed” from the TORTR, it goes back into the B2B regular transmission infrastructure, but with an appropriately designated recipient address, since the TORTR just “intercepts”, “traps” and/or “captures” orders “submitted” without destination information, or destined to the TORTR for some reason.

The TORTR does not modify the usual B2B “Point A to Point B” approach to transaction sending-and-receiving, but rather extends B2B by “plugging” to it. On the contrary, the TORTR allows the B2B-model and implementations to be viable for outpatient healthcare messages since it doesn't interfere with the social practices of patients of going to their preferred products and/or services providers instead of being forced to particular providers, and doesn't modify existing B2B electronic message transmission infrastructures, but rather automatically extends these without modifying them, since it relies on these for final message delivery.

It is therefore the object of the present invention, the TORTR, to be available to handle outpatient medical orders and other point-to-point messages in order to expand the capability of the existing B2B Orders and Results model (which is currently an extension of the inpatient model into the outpatient setting) to make the B2B Orders and Results model outpatient-sector friendly, compatible and malleable.

It is another intent of the TORTR to give back to the patient the decision-making “right-to-choose” and freedom to select providers they've come to appreciate and protect wholeheartedly.

Using the claims-for-patent (defined in the CLAIMS section of this document) elsewhere in this patent submission we can summarize the TORTR (the invention) as follows:

A patient goes to a healthcare provider with the capability to generate electronic orders and receive electronic results. Using whatever means or tool the ordering providers has at his/her disposal, he/she creates an electronic order (electronic medical order) for some healthcare product of service (ex. electronic prescription, electronic clinical laboratory test order, electronic diagnostic procedure and/or test order, electronic consultation, electronic referral, electronic imaging-type study (X-Ray, CT-Scan, MRI, etc.) order, electronic appointment, or other product and/or service that can be “ordered” and/or “requested) for the patient. Then, instead of defining a specific destination to sent the electronic order (request) to, submits the order without a destination defined and/or to the TORTR, so that a final destination (the place where the electronic order should arrive via electronic communications) can be defined at a later date/time, by another provider, or by the patient, amongst others.

Therefore, the method, system and/or invention is the TORTR; which is activated once an electronic transfer of information is initiated but without destination information or by selecting the TORTR as destination, amongst a plurality of other possibilities.

Once orders are collected by the TORTR, the TORTR saves them according to the type of order they are (i.e. ePrescription, eLab, eImaging, eConsult, eReferral, and/or any other medical order and/or message of its kind), in their native transaction-standard format or in an intermediate format, and a status of “unclaimed” is initially given to the corresponding order; unless another value is specified for status.

By saving orders by type the TORTR can verify that all data-elements and/or components for such type of order are present so when routing is performed at a later time it knows through the route, mechanism and/or network the order should take.

Once orders are in the TORTR, other healthcare professionals that can receive and fulfill the orders, but not before searching the TORTR (or assign personnel to perform the search on their behalf) for “unclaimed” orders and limited to their line of work. Healthcare professionals that can search for unclaimed orders include, but are not limited to, pharmacists, medical technologists, appropriate provider-office personnel, etc.; just to name a few. Order searches are done using properties that identify the patient and/or the provider who created the order, NO UNIQUE ID is issued to an order nor required, and TORTR is queried for orders using a plurality of parameters and/or properties of the order, appropriate for the order type. For example, orders are searched by a minimal set of properties that uniquely identify a patient's order such as last name(s), first name, date of birth, gender and zip code, amongst others; as allowed by law to be used by healthcare providers for providing health care services, payment and/or operations.

In the U.S.A, assigning a Patient ID has been avoided for many years and many reasons. Privacy-Rights advocates resist the creation of a national or universal patient ID and giving these to people as they see the potential of intrusion into personal privacy, and in the case of healthcare, if abused, could lead to greater repercussions that simple identity theft as we see today. Other jurisdictions and/or countries may face the same dilemma.

Giving a patient an Order-Unique ID (such as a sheet with an order, invoice and/or reference number or ID that identifies a patient's order) is discouraged since it continues and exacerbated the use of paper (and the patient has to carry the sheet with the ID in written and/or encoded manner); and one of the main efforts behind which electronic orders and results is to reduce or eliminate paper in the process. Also, the use of other electronic media forms (ex. smartcards, or other writable or rewritable media) has proved to be expensive, prone to damage in route to the ordering provider, easily lost, easily erased, and mostly not supported by patients accustomed to more traditional means of data-relay from one point to another or simply depending on the advances, ease and benefits of electronic data interchange. Finally, memorizing a code or ID by the patient is highly uniquely to work in, and for, the vast majority of the population.

TORTR uses search-engine-technology widely and openly available technologies and techniques (examples which include Apache Lucene, widely-used database techniques, and open source master patient/person index technologies), to retrieve patient orders. To this end the TORTR searches for unclaimed and/or other electronic orders using the aforementioned techniques, technologies and plurality of patient properties and/or parameters.

Search-results are immediately presented when a single patient-order is found that matches the search criteria. If a single patient match cannot be 100% identified, additional properties can be used such as the last four digits of a telephone number, or last four (or other number) digits of the health insurance card number (HICN), and so on. If in spite these additional criteria TORTR cannot find a single patient match, then TORTR retrieves and lists entries that have a 98% or better confidence-level (probability) of being the correct patient-orders. Orders are listed with minimal patient identifying information and order-fulfiller selects the correct patient order after validating and identifying the correct one. Therefore, no Unique ID Code is used for patient-order search and identification.

Nonetheless, since the technologies to accomplish this feat are standard and open source products available to anyone, the TORTR/invention is NOT pursuing nor “claiming” anything upon the aforementioned openly available techniques and technologies used to search for orders and/or individuals temporarily stored in TORTR without using a Unique ID code, but rather we state that we use and incorporate such technologies to achieve the effect desired, and eliminating the need for a Unique ID Code to do order searches in TORTR.

Also, searches are limited to the line-of-work of the person conducting the search; hence, pharmacists cannot search for clinical laboratory tests orders and vice versa, and so on. Also, searching can be issued using a web browser using HTML pages presented to the searcher by the TORTR, or searches can be accomplished from within another HIT tool or system (ex. a pharmacy information system (PIS), clinical laboratory information system (LIS), radiology information system (RIS), or applicable system according to order type) that adopt and use an web service API that grants access to searching for unclaimed orders, and other data handling capabilities available in the TORTR, and made freely-available to recognized and validated HIT vendors that provide Orders & Results oriented capabilities within their systems.

When the TORTR identifies unclaimed orders that match the search parameters provided, it presents these in summarized manner to the searcher so he/she can verify that the appropriate order, for the correct patient, and from the correct ordering provider, is being looked at. Verification can be performed using a web browser and HTML pages that present the order to the searcher by the TORTR, or from within another HIT-related tool or software that adopts and uses the API (mentioned previously) that allows interaction with the TORTR (ex. searching, displaying result-sets from TORTR searches, etc.).

Once the correct unclaimed order has been identified and verified, it can be “claimed” so it is routed to a particular electronic address (location); most likely the same place from where the search for the unclaimed order is being performed. The act of “claiming” and/or routing the electronic order constitutes the act of defining a specific destination to sent the electronic order through the appropriate venue and/or means as if the destination had been defined when the order was created.

“Claiming” and order can be performed using a web browser and HTML pages provided by the TORTR to the searcher, or from within another HIT-related tool or software that adopt and use an API (mentioned previously) that allows for “claiming” unclaimed, searched and verified orders from the TORTR.

The TORTR can be used to inform ordering providers that an order has been “claimed” and/or fulfilled (for example, to notify a provider that a prescription has been dispensed, or that a clinical laboratory test has been performed, etc.) Notifying order fulfillment can be performed using a web browser and HTML pages provided by the TORTR to the order fulfillment performer, or from within another HIT-related tool or software that adopt and use an API (mentioned previously) that allows for “notifying order fulfillment” of “claimed” orders from the TORTR.

Once “claimed”, the TORTR routes the transaction using the B2B customary trail, standards, communications infrastructure, network, and/or protocols as an order that had a destination defined since the beginning of its creation and that never passed through the TORTR.

However, there may be cases where after “claiming” an order, the party that “claimed” the order, and got it routed and electronically delivered to it, cannot fulfill the order for any reason. The TORTR allows a “claimer” (destination) to restore an order back into the TORTR so another party can “claim” the order and fulfill the order. As one of a multitude of examples, imagine a pharmacy that “claimed” an electronic prescription and later found out that it is out-of-stock of the ordered medication. The pharmacy may decide to return the electronic prescription to the TORTR so another drug-store can “claim” the electronic prescription and dispense the ordered medications. This capability allows orders to be routed and re-routed as needed in a healthcare-environment comprised of products and/or services providers physically-distant from one another, mostly independently-operating, in a free-market and value-driven environment where competition is sometimes conceded for the benefit of the patient. Without the TORTR, and based on the current ePrescribing model and transactions set forth by the MMA, there is no way of guaranteeing pharmacies can transfer electronic prescriptions from one another in the event one cannot fulfill the order, so this returning of “claimed” orders allows for transfers to occur whereas without the TORTR they may not be possible, or might never occur.

Another situation that hardly occurs since performing it is extremely complex and time-consuming in a non-electronic environment, is that of inquiring several product and/or service providers about their products and/or services before committing a patient to a particular provider (such as “Order-Undergoing-Inquiry-Before-Commit” or OUIBC). Taking ePrescribing again as one of a multitude of examples, many times providers and/or patients have to research various pharmacies to identify which one has the medications ordered in-stock and in sufficient quantities, determine the final price to the patient, etc. The TORTR will improve such scenarios, and could even promote them, by allowing orders to be submitted as “inquiries” (the order's status would not be that of “unclaimed”, but rather of an “OUIBC”) to various potential pharmacies, and depending on the reply's received, the most beneficial pharmacy for the patient can be defined as the electronic prescription destination; either by the ordering provider and/or by the patient visiting such order-fulfillment provider.

Orders in the TORTR are given an expiration and/or due-date. Other orders have automatic inactivation dates set forth by law and/or regulation, as for example, but limited to, prescriptions of controlled substances; where prescriptions have to be dispensed within 24 hours of being prescribed or the prescription ceases to be valid according to current Federal Drug Administration (FDA) rules, amongst other examples applicable to order type and what is ordered. Therefore, unclaimed, expired, due or invalid orders are marked for purging by the TORTR. Nonetheless, the ordering provider is notified that the order of particular type, for the particular patient, will be purged from the TORTR, and why, so appropriate action can be taken by the provider.

Finally, all transaction communications and exchanges, regardless of human-computer interface approach (HTML, API, etc.) utilized by providers and other end-users, are communicated and exchanged using secured communications with encryption regardless of being through the Internet or other network(s) or communications mean.

### BRIEF DESCRIPTION OF THE DRAWINGS

The novel features believed characteristic and unique of the TORTR/Invention is that is allows B2B-commerce-transactions to be performed in the outpatient healthcare setting by extending the basic premises of B2B (that a transaction goes from Point A to Point B), without altering existing B2B infrastructures and/or systems that might be in place, by allowing Point B to be defined AFTER Point A has culminated its work (original place and/or moment of creation of the electronic transaction) by another party that does not have to be one that generated the transaction at Point A. This means, that B2B transactions are issued without destination and/or destined to the TORTR, and hence intercepted and/or captured by the TORTR, until some other party designates the Point B destination. That other party may be another healthcare provider or professional, or the patient itself when he arrives and/or informs a potential Point B to “claim” the transaction created at Point A to the location where the patient is at the time. Once a destination (Point B) is defined, the transaction returns to the customary B2B transaction handling trail and/or infrastructure standards and protocols as usual until it reaches its recipient/destination (as if Point B has been defined by the ordering-provider in the first place). In addition, the drawings are intended to be illustrative and explanatory of one or a few possible embodiments, from a plurality of possible embodiments and/or combinations thereof, of the invention, and not limitative in any way.

FIG. 1A depicts the current relationship that exists between major ePrescribing stakeholders as described in the ePrescribing preferred embodiment first paragraph (without a TORTR) and occurring between ePrescribing-participants through existing intermediate ePrescribing-Network-Exchanges. We could title this figure as Current Electronic Medical-Orders Exchanges via Existing Intermediate Network-Exchanges that Interconnect Major Electronic Orders and Results Players (ex. current ePrescribing model).

The figure represents the relationships and message exchanges that exists through the current-model and at the current-moment, as of this writing (where a TORTR doesn't exist) and transactions travels from Point A to Point B via an existing intermediate network-exchange that does backend routing and messaging based on a normalized transaction following a standard-implementation-guide. The figure illustrates the existing relationship between the ordering-Provider, Pharmacies and PBM/Payers as a rectangle, as well as the Provider-to-PBM-to-Provider network exchange (104a) and Provider-to-Pharmacy-to-Provider network exchange (103a).

The prescriber (in the case of ePrescribing) uses a tool or system that allows him/her to create electronic prescriptions (100a). It first communicates with the Pharmacy Benefit Managers (PBMs) (representatives of payers/health insurance companies) sending inquiries for patient eligibility (102a, downward) to the PBM-network-exchange (104a) which connects PBMs-to-Prescribers, and PBMs responding to the PBM-Network-Exchange inquiries (106a). The PBM-Network-Exchange looks for a patient in its master patient/person index (104a) and identifies if the patient is eligible, and with whom (since the patient may be eligible with more than one company and/or coverage; such as having co-insurance, double-insurance coverage, etc.). The PBM network-exchanges then inquires the appropriate PBM(s) (106a, downward) for patient eligibility(ies), coverage(s), applicable formulary(ies) (list of drugs covered under the patients coverage), and medication history(ies) (drugs paid-for by the PBMs for a particular patient).

PBM-systems (108a) gather inquiries for patient information and return any information found to the inquiring PBM-network-exchanges (106a, upward). The PBM-network-exchange then responds to the prescriber with all the information it's able to collect from the various PBM(s) (102a, upward) and the prescriber is presented with such data through his/her tool or system of choice (100a).

The prescriber, based on the eligibility information received, applicable formulary(ies) and medication history(ies) received (102a, upward) begins defining/selecting drugs for prescription that comply this the patient's eligibility and that are covered by the patient's applicable formulary, using the tool at his/her disposal (100a). Once the prescription is complete, and possible drug interactions compared to drugs in medication history available to the prescriber from the PBM from prior prescriptions, the prescriber signs and submit the electronic prescription to the applicable Pharmacy-network-exchange (101a, downward).

The pharmacy-network-exchanges then validates that the electronic prescription is complete and compliant with pharmacy transactions standards and requirements (103a). If the transaction passes validation and standard compliance testing, the pharmacy-network-exchange routes the electronic prescription to the designated final destination (pharmacy) (105a, downward). If, on the other hand, the pharmacy-network-exchange, during validation and/or completeness-verification, finds any discrepancy or inconsistency with the electronic prescription, it returns a message back to the prescriber alerting of the issue (101a, upward) so the electronic prescription can be corrected and re-submitted to the pharmacy-network-exchanges for re-validation and compliance testing (103a). Finally, once an electronic prescription is validated and compliance-certified, the pharmacy-network-exchange routes and delivers the electronic prescription to designated pharmacy (105a, downward), which receives the electronic prescription into its pharmacy information system (107a).

Thereafter, what pharmacies do with prescriptions, such as communicating with PBMs to be paid for dispensing the drugs and the drugs themselves (109a, 111a and 110a) are the same steps pharmacies have been doing between pharmacies, PBM and payer for well over a decade and do NOT interfere nor constitute ePrescribing per-se.

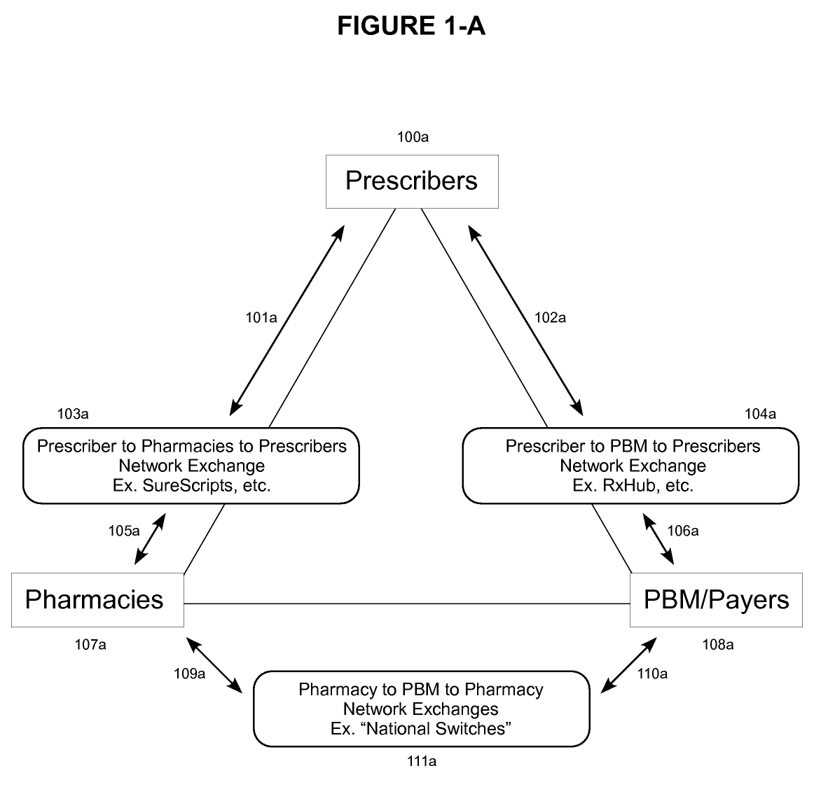

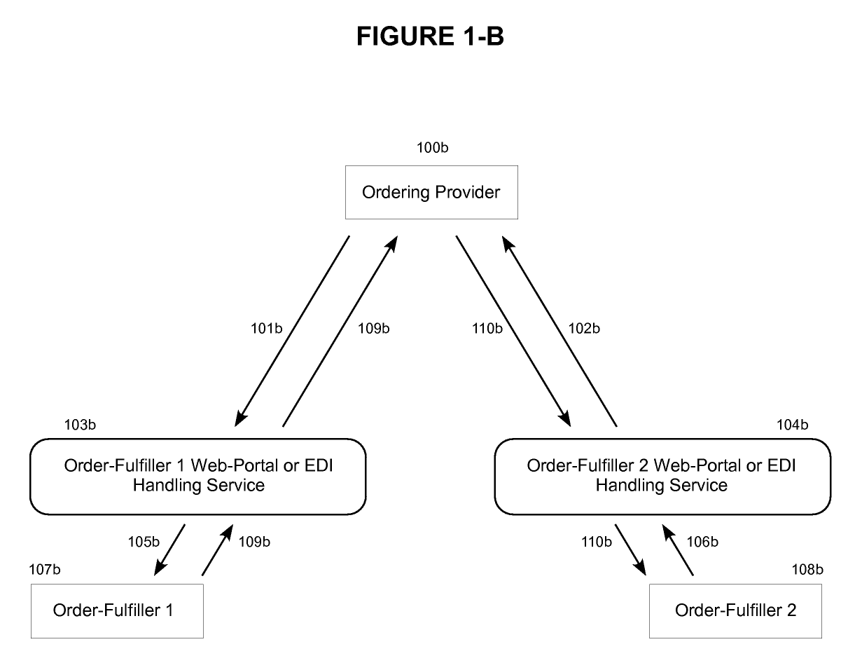

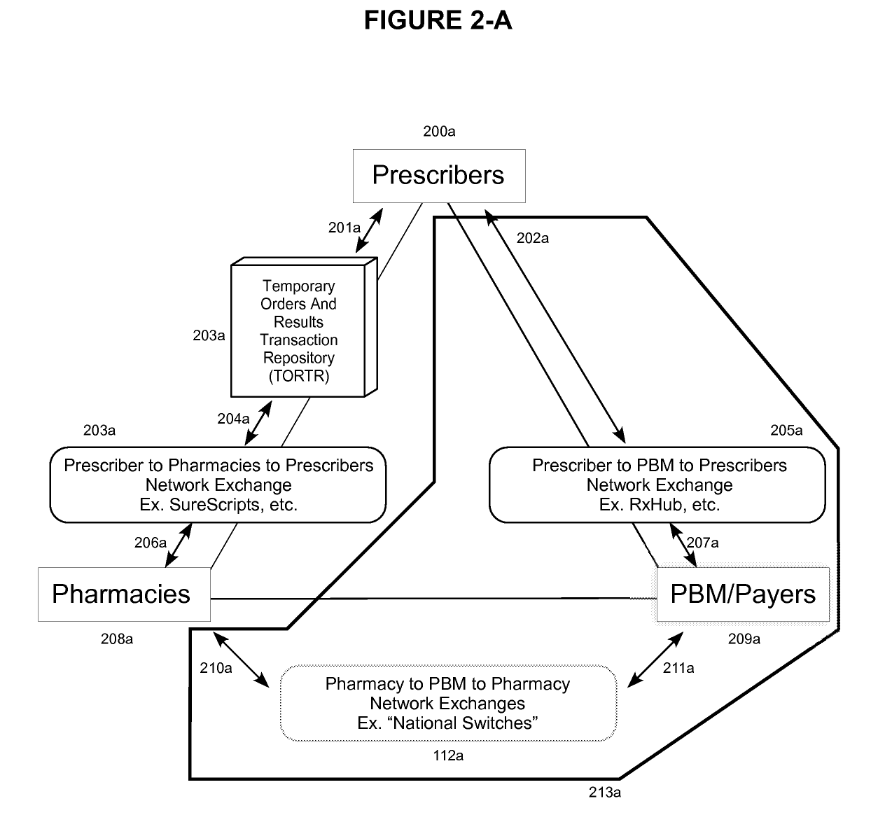

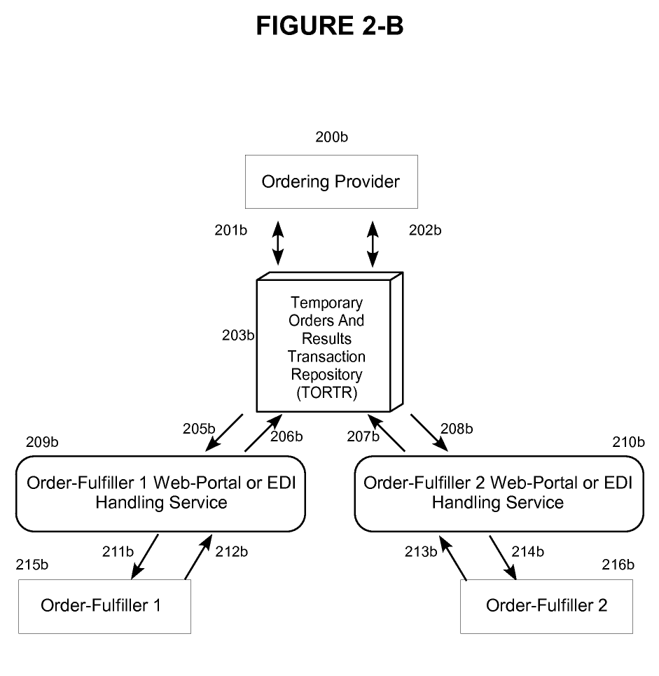

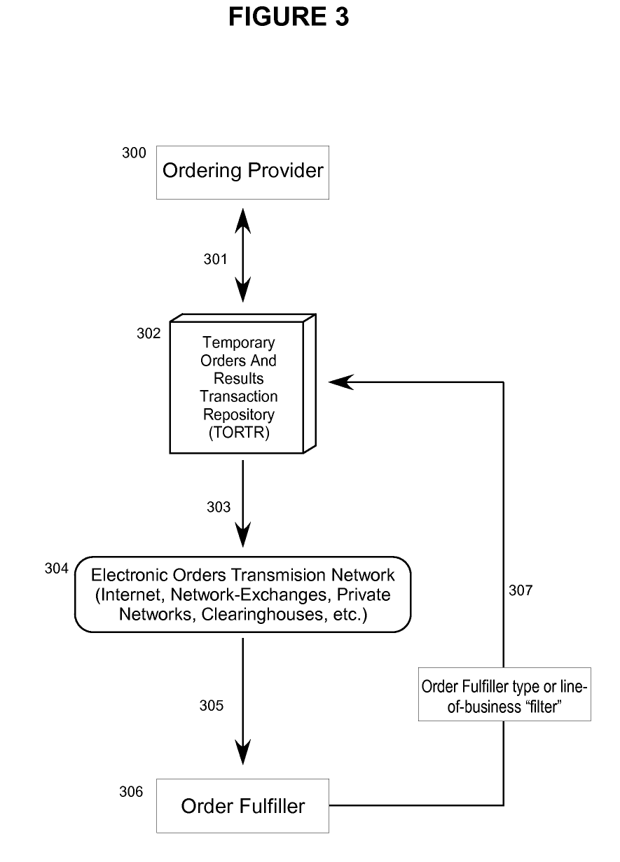

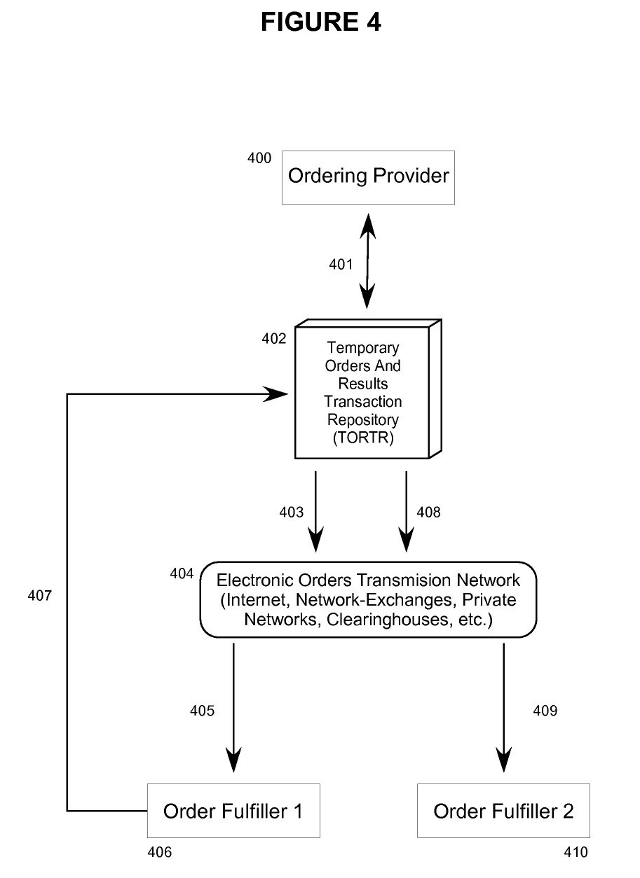

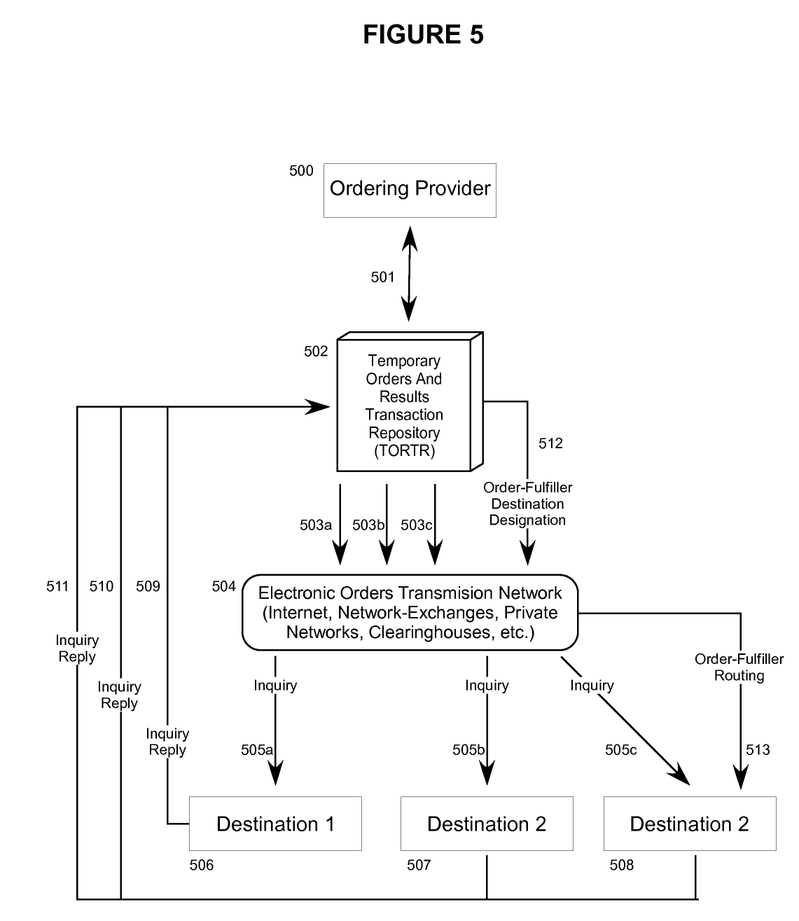

FIG. 1B depicts the relationship that exists between electronic ordering providers and other electronic products and/or service fulfillers that do NOT have specialized or existing intermediate network-exchange(s) for transaction handling; thus have their own proprietary web portals and/or EDI services specific to each order fulfiller. We could title this figure as Current Electronic Medical-Orders Exchanges via Proprietary Portals or EDI Handling Services to Interconnect Major Electronic Orders and Results players (ex. current eLabs and eImaging models, etc.)

The figure represents the relationships and message exchanges that exists between independent entities with their own portals and EDI services and implementations to receive electronic orders (applicable to their line-of-work) and where a TORTR doesn't exist that could serve, amongst other things, to normalize and standardize the various portal and/or EDI implementation guides and requirements to a more uniform transaction-implementation that would fulfill the needs of all individual electronic product and/or services order fulfillers.

The ordering provider uses a tool or system that allows him/her to create electronic orders (100b) of different kinds (eLabs, eImaging, eConsults, amongst many others) Such a tool or system communicates directly with the various order fulfillers (107b and 108b) by adopting and implementing the various order fulfillers implementation-guides to gain access to their portals and/or EDI services (101b and 102b); hence the ordering systems are limited to the number of order-fulfillers they can support since implementations vary from order-fulfiller to order-fulfiller and the number of order-fulfillers cannot be determined; in essence, connectivity to each order-fulfiller constitutes a different integration work and/or interface, hence costs for ordering providers rise exponentially the more fulfillers they support and/or connect to.

Once an electronic order arrives at an order-fulfiller portal or EDI service, it is transferred to their respective information systems (101b, 102b, 103b, 104b, 105b and 106b). For example, if order-fulfiller 1 is a clinical laboratory, the electronic order enters the laboratory information system (LIS) (107b), while if the order fulfiller 2 is a diagnostic imaging center (ex. X-Ray provider), the electronic order enters the radiology information system (RIS) (108b).

Finally, once the orders are fulfilled, each fulfiller returns their respective results to the ordering provider (109b and 110b,), possibly via their portals and/or other EDI services if results are returned electronically.

FIG. 2A depicts the relationship exists between ePrescribing provider and patient stakeholders (as described in the ePrescribing preferred embodiment), from the second paragraph onward; where the ePrescribing process utilizes the TORTR so that a order destination can be defined at a later time rather than during the patient-provider encounter. We could title this figure as Temporary Orders and Results Transaction Repository (TORTR) Intervention in an Electronic Medical-Orders Exchange via Existing Intermediate Network-Exchange that Interconnect Major Electronic Orders and Results Players (ex. ePrescribing model with TORTR intervention).

NOTE—The delimited area (213a), which encompasses the rightmost and bottom portions of the figure elements in FIG. 1A have been surrounded to represent that these areas are NOT affected nor interfered-with in any way by the TORTR/invention in the ePrescribing embodiment depicted, for illustrative purposes only, in drawing 2A. Again, the drawings are intended to be illustrative and explanatory of one or a few possible embodiments, from the plurality of possible embodiments and/or combinations thereof, of the invention, and not limitative in any way.

As in FIG. 1A, transactions travel from Point A to Point B via intermediate network-exchanges; but in this case, the TORTR resides, or is plugged, between the prescriber and the pharmacy-network-exchanges to capture all messages where a destination (pharmacy) is NOT defined for any reason or for which the TORTR has been defined as destination.

Ordering providers (prescriber in the case of ePrescribing) who uses a tool or system that allows him/her to create electronic prescriptions (200a) has already communicated with the PBMs, verified eligibility and medication history and is about to define an order destination. However, not knowing, or not wanting to define a final destination, the ordering provider leaves the destination information undefined and the electronic order is sent (201a, downward) to the pharmacy-network-exchanges (103a) but the transaction is intercepted and/or captured by the TORTR (203a, downward) (for lacking destination information or because it was destined to the TORTR) to await that someone or something undertakes the step of defining the destination of the electronic message; which will then continue its usual and expected B2B trail (204a, downward) towards its final destination.

NOTE—Messages submitted with a destination defined, other than the TORTR, are not even touched nor intervened-with by the TORTR; they pass through the communications infrastructure as if the TORTR didn't exist.

Once the unclaimed order (an order with undefined final destination or destined to the TORTR) in the TORTR is searched and verified to the one sough-after, it is “claimed” (requested by a “claimer”) by an appropriate party (limited to their line-of work; hence, pharmacies will only be able to see prescriptions, clinical laboratories will only be able to see clinical laboratory test requests, and so on, respectively) (203a), it is given a destination address and put back in the B2B trail and sent to the pharmacy-network-exchange (204a, downward). The pharmacy-network-exchanges validates that the electronic prescription is complete and compliant with pharmacy transactions (ex NCPDP or others) standard requirements (203a), and if successful, routes the electronic prescription to the designated destination (pharmacy) (206a, downward) defined by the “claimer”. On the other hand, if the pharmacy-network-exchange cannot validate and/or finds any discrepancy with the electronic prescription, it returns a message back to ordering prescriber, through the TORTR, (204a, 203a and 201a, upward). Once the electronic prescription is corrected, it is re-submitted to the pharmacy-network-exchanges for re-validation and compliance testing, and if successful (203a), the pharmacy-network-exchange routes and delivers the electronic prescription to the designated pharmacy (206a, downward) and the electronic prescription is received by the pharmacy information system in place at the destination pharmacy (208a).

FIG. 2B depicts the relationship that exists between electronic ordering providers and other electronic products and/or service fulfillers that DO NOT have a specialized or existing intermediate network-exchanges; thus have their own proprietary web portals and/or EDI services specific to each order fulfiller. We could title this figure as Temporary Orders and Results Transaction Repository (TORTR) Intervention in Current Electronic Medical-Orders Exchanges via Proprietary Portals or EDI Handling Services to Interconnect Major Electronic Orders and Results Players (ex. eLabs or eImaging models with TORTR intervention)

The figure represents the relationships and message exchanges that exists between independent entities with their own portals and EDI services to receive electronic order (applicable to their line-of-work) and where a TORTR exists to serve, amongst other things, to normalize and standardize the various portals and/or EDI implementation guides and/or requirements to a more uniform transaction-implementation that would fulfill the needs of all individual electronic product and/or services order fulfillers, if required due to lack of regulation and/or law in this matter.

The ordering provider uses a tool or system that allows him/her to create electronic orders (200b) or different kinds (ePrescription, eLabs, eImaging, eConsults, etc.). Once the order is completed, the ordering provider sends the order (201b and 202b, downward) but the transaction is intercepted and/or captured by the TORTR (203b) (for lacking destination information or because it was destined to the TORTR) to await that someone or something undertakes the step of defining the destination of the electronic message; which will then be routed to appropriate order fulfillers (205b and 208b) by adopting and implementing the various order fulfillers implementation-guides to gain access to their portals and/or EDI services (209b and 210b).

NOTE—Messages submitted with a destination defined, other than the TORTR, are not even touched nor intervened-with by the TORTR; they pass through the communications infrastructure as if the TORTR didn't exist.

Ordering systems, which are usually limited to the number of order-fulfillers they can support since implementations vary from order-fulfiller to order-fulfiller and the number of order-fulfillers cannot be determined, benefit from the TORTR since though it interfaces to each order-fulfiller are taken out of the equation and costs minimized by economies of scale.

Once an electronic order arrives at an order-fulfiller portal or EDI service, they are transferred (211b and 214b) to their respective information systems (215b and 216b). For example, if order-fulfiller 1 is a clinical laboratory, the electronic order enters the laboratory information system (LIS) (215b), while if the order fulfiller 2 is a diagnostic imaging center (ex. X-Ray provider), the electronic order enters the radiology information system (RIS) (216b).

Finally, once the orders are fulfilled, each fulfiller returns their respective results to the ordering provider (212b and 213b), possibly via their portals or EDI services (209b, 210b, 206b and 207b) if the results are returned electronically. These results are routed through the TORTR, which undertakes the part of the role of network-exchange to help deliver the results of the respective tests, products and/or services originally ordered to the ordering provider.

Finally, the ordering provider sees the results returned to him electronically (201b and 202b, upward), in their respective Orders and Results tool or system (200b).

FIG. 3 depicts how orders sent by ordering providers (300), and either captured, intercepted or send directly (301) to the TORTR (302), using their electronic orders and results or system or choice (300) capable of issuing orders to destinations outside their place of work (entity), are “searched” and “claimed” by medical “order fulfillers” (306 and 307). We could title this figure as Searching and Search-Result-Validation of Unclaimed Orders in the Temporary Orders and Results Transaction Repository (TORTR) by Order-Fulfillers.

Ordering providers use a tool or system that allows him/her to create electronic medical orders (300) and complete the appropriate electronic medical order (ePrescribing, eLabs, eImaging, eConsults, etc.) up to the point of designating the order's destination. However, not knowing, or not wanting to define a final destination themselves, the ordering provider leaves the destination information undefined and/or define the TORTR as destination and “sends” the order message/transaction (301, downward). The transaction is intercepted and/or captured by the TORTR (302) (for lacking destination information or because it was destined to the TORTR) to await that someone or something undertakes the step of defining the destination of the electronic message (307); which will then be routed (303, 304 and 305) to appropriate order fulfillers (306) by continuing the usual B2B trail (303, 304 and 305, downward) towards its destination (306), the order fulfiller.

NOTE—Messages submitted with a destination defined, other than the TORTR, are not even touched nor intervened-with by the TORTR; they pass through the communications infrastructure as if the TORTR didn't exist.

Orders fulfillers connect (section 307) to the TORTR (section 302) through user-accounts they have in the TORTR that not only grant them access to the TORTR but also have a description of their healthcare provider type and/or line-of-work (ex. pharmacists, medical technologists, etc.) Searches are then limited to a searching provider's type and/or line-of-work (ex. pharmacists can only search for medication prescriptions, medical technologists can only search for clinical laboratory tests requests, and so on, respectively).

Unclaimed orders search are performed via web pages and HTML (issued by TORTR servers) or API (that grants access to searching for unclaimed orders, and other data handling capabilities available in the TORTR, and made freely-available to recognized and validated HIT vendors that provide Orders & Results oriented capabilities within their systems) that allows querying (searching), verification that correct unclaimed order are being looked-at, “claiming” unclaimed electronic orders, returning “claimed” electronic orders back to the TORTR, and even notifying fulfillment of the order to ordering providers, amongst other data management capabilities.

Once orders from the TORTR are searched, limited by order fulfillers type, and WITHOUT THE USE OF UNIQUE ID issued to an order (but rather using a plurality of parameters and/or properties of the order and appropriate for the order type), when the order is found and validated, it is “claimed” by the order fulfiller and are routed (section 303) to the order-fulfillers destination address by means of the customary and usual B2B transaction trail (304 and 305) by leaving the TORTR (302) and end up in the order fulfiller's system (306) for order fulfillment.

Finally, once the electronically solicited orders are fulfilled, each fulfiller returns their respective results electronically, through the TORTR to the ordering provider (301, upward), who receives such information in their respective tool or system (300). If results are returned through the TORTR, then the TORTR partially undertakes the role of network-exchange for the receiving ordering providers until they have been delivered the results of the respective tests, products and/or services originally ordered.

FIG. 4 depicts how one order fulfiller (406), who has “claimed” an electronic order (402, 403, 404, 405 and 406), can return a “claimed” order back (407) to the TORTR (402), so other order-fulfillers (410) can then “claim” the order (402, 408, 409 and 410) for order fulfillment. We could title this figure as Temporary Orders and Results Transaction Repository (TORTR) Receiving a Returned Electronic Order, Setting the Returned Order as Unclaimed, and Allowing a Second Order Fulfiller to Claim the Order for Fulfillment.

Ordering providers who use a tool or system that allows him/her to create electronic medical orders (400) completes the appropriate electronic medical order (ePrescribing, eLabs, eImaging, eConsults, etc.) up to the point of designating the order's destination. However, not knowing, or not wanting to define a final destination themselves, the ordering provider leaves the destination information and sends the order with destination information undefined and/or define the TORTR as destination (401, downward). The transaction is intercepted and/or captured by the TORTR (402) (for lacking destination information or because it was destined to the TORTR) to await that someone or something undertakes the step of defining the destination of the electronic message (407, representing a TORTR search); which will then be routed (403, 404 and 405) to appropriate order fulfillers (406).

NOTE—Messages submitted with a destination defined, other than the TORTR, are not even touched nor intervened-with by the TORTR; they pass through the communications infrastructure as if the TORTR didn't exist.

Order-fulfillers search for unclaimed electronic orders as depicted under the “Summary of the Invention” section. However, there are cases that an order-fulfiller cannot fulfill an order after having “claimed” and routed the order to his location, operations and/or practice. As a matter of example, a pharmacy may notice that it ran out-of-stock of the prescribed medication after having “claimed” an electronic prescription, or a clinical laboratory may note that the supplies required to perform a test ran out-of-stock, or for whatever other reason. The TORTR allows an order-fulfiller, who had “claimed” an order and has not yet identified the order as fulfilled in the TORTR (and hence the TORTR has not issued an appropriate order fulfillment message to the ordering provider), to “return” the electronic order back to the TORTR (407, representing a TORTR return) as unclaimed so another order-fulfiller can “claim” and fulfill the order.

Orders returned to the TORTR, being identified as unclaimed, are then searched by subsequent order-fulfillers as they always do when searching for unclaimed electronic orders in the TORTR.

When a new order-fulfiller then “claims” the electronic order, it is routed (408) to its defined address (409) so the new fulfillers system ( (410) accepts the incoming electronic order and order fulfillment is performed.

FIG. 5 depicts a somewhat complicated scenario that occurs every day mainly by medically-indigent patients and/or those with low income. Nonetheless, this current scenario, being conducted today manually, through phone calls, or by visiting various order-fulfillers, without TORTR attests to the lengths some patients have to go to have medical orders fulfilled and a case that would be greatly simplified by the implementation through the TORTR. We could title this figure as Temporary Orders and Results Transaction Repository (TORTR) Multicasting Orders as Inquiry to Various Potential Order-Fulfillers Before Defining Order Destination to a Particular Order-Fulfiller Based Upon the Replies Received from Inquiries.

Ordering providers who use a tool or system that allows him/her to create electronic medical orders (500) and completes the appropriate electronic medical order (ePrescribing, eLabs, eImaging, eConsults, etc.) up to the point of designating the order's destination. However, wanting to know to which destination to send the electronic order (501, downwards), the provider sends the electronic order to the TORTR (502) with a status of “Order-Undergoing-Inquiry-Before-Commit (OUIBC) instead of unclaimed (501, 502, 503a, 503b and 503c) and destined to various potential order-fulfillers (505a, 505b, 505c, 506, 507 and 508) who receive the inquiry for the order, through the TORTR. Because of the status of the order (OUIBC), the inquired potential destinations (506, 507 and 508) reply to the inquiry and based on their replies (509, 510 and 511) they may or may not be chosen to have the order destined to them.

For a matter of example, a doctor may ask various pharmacies about the availability of a specific drug that the prescriber is ordering, if there are sufficient in-stock for the prescription, and/or the price to the patient, etc. Another example would be that of ordering durable medical equipment (DME) for a patient (wheelchair, oxygen-concentrators, special beds, etc.) where the ordering provider inquires various DME suppliers for availability and pricing so the patient can chose its best option.

Finally, once inquiry replies are received back in the TORTR, a decision is made by the ordering provider, the patient and/or both and either a final destination is defined by the ordering provider to fulfill the order, or the ordering provider may change the status of the order to unclaimed and allow the patient to go directly to the preferred order-fulfiller so the order is “claimed” and fulfilled 502, 512 and 513).

In any case, this capability will allow low-income or medically-indigent patients to research purveyors of the products and/or services they've been medically ordered so they may choose the most cost-efficient and/or beneficial order-fulfiller; much like Internet sites that compare prices of items at various vendors so the buyer may purchase from the best vendor, but in this case the TORTR works specifically for electronic medical orders to attain information about the most competitive healthcare products and/or services providers.

### DETAILED DESCRIPTION OF THE PREFERRED EMBODIMENT

### Example of ePrescribing with the Preferred Embodiment of the TORTR/Invention

The current state-of-the-art ePrescribing model can be summarized as follows; a patient goes to a healthcare provider that is licensed to prescribe medications and who does ePrescribing. The prescriber uses an ePrescribing tool (either one created in-house or one provided by a vendor) with all the features deemed minimum necessary to comply with the current ePrescribing model such as (a) eligibility verification, (b) formulary access, (c) selection of drugs based on the patient's insurance coverage and applicable formulary, (d) list of medications that the patient has received in the past and/or that might be taking (“medication history”) arising from drugs previously paid for the patient's by the insurer(s) and/or that have been previously prescribed by the prescriber, (e) and the prescriber selects the desired drug(s), checking these to be sure they are covered by the applicable formulary, insurance, preference level, etc. and (f) is advised of drug interactions was well as other optional decision-support alerts (possible allergic reactions, diagnosis contraindications, etc. for each medication prescribed. Finally, the prescriber selects the pharmacy that will receive the electronic prescription (hopefully in consultation with the patient) electronically “signs” and “submits” the electronic prescription to the selected pharmacy via electronic communications through existing network-exchanges that have been instituted to facilitate the trading partner agreements and certifications that have to occur between such a large number of players (many doctors, whose prescriptions may arrive to a essentially unlimited number of pharmacies, with many PBM/payers serving the plurality of health insurance companies and insurance coverage's that exist; in essence a logarithmic-type number of possible message exchange relationships and/or permutation.
1. However, with the introduction of the TORTR/invention, after conducting the initial steps of ePrescribing and reaching the point of selecting a destination pharmacy for the electronic prescription, the TORTR/invention allows the prescriber to “sign” and “submit” the electronic prescription without destination and/or define the TORTR as destination which triggers the TORTR to intercept and/or capture the transaction for lacking destination information or because it was destined to the TORTR. This brings about advantages; amongst others (some out of scope of this brief description) and/or that might be identified at a later time as the TORTR is used and more experience gained which include: the patient may want to decide which pharmacy will dispense his prescription without a prescriber's intervention and/or assistance, or at a later time or place, thus the prescriber sends the electronic prescription to be intercepted by the TORTR so “definition of final destination” (selection of a pharmacy) is omitted by the prescriber.
2. The TORTR prevents patients from being “directed” to particular pharmacies; unless they accept, it is required contractually as part of the insurance coverage (such as in some managed care programs) and/or with mail-order prescription drug coverage, etc.
3. Definition of final destination (what we've refer to as “to claim” a TORTR unclaimed order) of electronic prescriptions sent to the TORTR is done by a licensed healthcare provider in the pharmacy chosen by the patient. For example, (a) the patient arrives at a pharmacy and tells the pharmacist that he/she has been prescribed some drugs from a prescriber, (b) the pharmacist goes into the TORTR through a gateway (web page, API, etc.) that allows pharmacists to query the TORTR for electronic prescriptions issued for patients and pending to be “claimed”, (c) the pharmacist uses patient information (Refer to “Summary of the Invention” and its description of orders searching for more information and details) and prescriber information to identify the electronic prescription(s), (d) after the pharmacist finds the electronic prescription and determines that it can be dispensed, the pharmacist “claims” the electronic prescription to its pharmacy (present location) as consented by the patient's presence. Once “claimed” the electronic prescription order/electronic-message is introduced back into in the appropriate B2B electronic prescription network (as if the prescriber had selected a pharmacy in the first place) and the electronic prescription routed to the pharmacy/location where the patient selected to have the dispensing performed. Last but not least, the pharmacist may also choose to use the TORTR to perform a “dispense notification” to the prescriber without having to incur in an additional ePrescribing transaction, by indicating in the TORTR that the electronic prescription has been “dispensed”; a capability most likely to achieve “dispense notifications” at reduced costs to all involved in ePrescribing compared to the handling of the transaction identified for such purposes by the Medicare modernization Act of 2003 (MMA).
4. Deferring definition of final destination (Point B) of electronic prescriptions is very accommodating if a patient doesn't know the name and/of address of his/her preferred neighborhood-pharmacy (such as it is more common with the elderly who customarily depend on these). Also, this may allow for scenarios such as the patient calling his/her preferred pharmacy to arrange for them to “claim” an electronic prescription so the prescription/medicine dispensing is ready when the patient arrived at his/her designated pharmacy.
5. electronic prescriptions handled through the TORTR gain an additional capability on top of allowing definition of electronic prescription destination. If for any reason the electronic prescription cannot be served/dispensed by a pharmacy who “claimed” the electronic prescription may return the electronic prescription it back to the TORTR so another pharmacy may “claim” it for dispensing. In these cases, if “dispense notifications” messages are requested by the prescriber, they are sent back to the prescriber through the TORTR but from a pharmacy prescriber wasn't expecting it from since it was the patient who ultimately selected the dispensing pharmacy(ies).
6. Some prescribers may adopt the habit of not defining final destination (Point B) of electronic prescriptions for any reason, including not to assume any responsibility of electronic prescriptions being routed to incorrect pharmacies and/or the potential of selecting the incorrect pharmacy from a list showing many with similar names and/or locations.
7. Prescribers (a.k.a. “Point A”) may send their prescriptions to the TORTR for “temporary holding” prior to additional processing; such as sending electronic prescriptions to the TORTR so some research and get back some replies about the orders products and/or services prior to definition of final destination (a.k.a. “Point B”) for the electronic prescription; in essence the order's status would be that of an “Order-Undergoing-Inquiry-Before-Commit (OUIBC), rather than an unclaimed order. For example, an electronic prescription can be sent to the TORTR and a multicast of “inquires for information” (ex. medication stock availability, final drug pricing, wait-times expected until the patient gets dispensed, etc.) to various pharmacies (a.k.a. possible” or “potential” Point B's). Then, once replies are received (either through electronic mail other transactions available in ePrescribing; such as “Point to Point Messaging”, or other communications means such as a telephone call, amongst others) and the information collected evaluated, the most cost-effective and/or beneficial final destination (Point B) can be defined so the electronic prescription reaches the best possible prescription fulfillment entity.

Also note that the “orders for medications” (electronic prescriptions) sent to the TORTR might have differing activation and/or expiration dates. For example, current Federal Drug Administration (FDA) rules require that “controlled substances” be dispensed within 24 hours or less of being prescribed, hence the TORTR will identify these and purge any medication orders that might violate regulations and notify the prescriber that the prescription has purged because it was not “claimed” in time or any other applicable reason; giving the advantage of letting know the prescriber of patient compliance with treatment as one more benefit.

In other cases, multiple prescriptions might be issued at once but with “escalating” or “contiguous periods” (ex. first prescription from January 1 to January 30 (with or without special administration instructions), second prescription for February 1 to February 28 (with or without special administration instructions), third from March 1 to March 30 (with or without special administration instructions), and so on. Dates of effectiveness and expiration (ex. whenever a prescription requires “new” prescriptions for each “refill”, as required by the payer for dispensing), hence the TORTR would address the prescriber's needs by allowing the prescriber to prepare various prescriptions that will automatically become “new” as their activation date arrives and allow several prescriptions to be placed in the equivalent of a “queue”, so they are sent to the destination pharmacy when their effective date arrives, automatically permitting the patient to visit his/her pharmacy of choice to receive the medications ordered by the next “new” prescription in line from the TORTR; without having to re-visit or interrupt the prescriber periodically. However, many ePrescribing applications have added a capability to create sequential prescriptions that are sent-out automatically based on an effective date. Nonetheless, if this process is performed via the TORTR, any prescription not dispensed to the patient by a pharmacy in time are notified to the prescriber; giving the added benefit of informing the prescriber of their patient's-compliance with treatment; built-in features in ePrescribing applications cannot elicit such alerts since they would depend on the dispensing pharmacy's willingness to send a “dispense notification” message to the prescriber; which is envisioned in ePrescribing but not used due to costs for the additional electronic transaction. The TORTR would eliminate the need for “dispense notification” transactions since it allows “claimed” and dispensed electronic prescriptions to subsequently be identified as “dispensed”, bypassing the need for pharmacies to issue their own and/or separate “dispense notification” electronic-messages to the prescriber's and hence eliminating such costs from the ePrescribing process.

The advantages numbered and depicted above cannot be achieved with current the ePrescribing model and/or implementation unless the intermediate TORTR is instituted.

### Example of Electronic Clinical Labs with Embodiment of the TORTR/Invention

Implementing the TORTR in an electronic clinical laboratory (eLabs) setting can be viewed as; as a patient going to a healthcare provider that is licensed to request clinical laboratory tests and getting an “order” to go to a clinical laboratory, go to a clinical laboratory to have tests/analyses performed to establish the patient's health status, potential health threats and/or determine the occurrence of a health related episode. The doctor (or other healthcare licensed professional) uses features similar to those available under the ePrescribing model (verify eligibility, insurance coverage, etc.) and can even be advised of possible complications due to products that may be used. The test ordering provider, however, after finalizing the eLabs order “signs” and “submits” the order without defining and/or identifying a specific clinical laboratory recipient (destination), or defining the TORTR as recipient, for the electronic message/order; which triggers the TORTR to intercept and/or capture the transaction for lacking destination information or because it was destined to the TORTR.

This allows for many advantages; amongst others (some out of scope of this brief description) and/or that might be identified at later include:
1. The patient may decide which clinical laboratory will fulfill his tests without the doctor's intervention and/or assistance, or at a later time or place, thus the doctor sends the order to the TORTR so “definition of final destination” (selection of a clinical laboratory) is omitted by the ordering provider.
2. The TORTR prevents that patients be “directed” to a particular clinical laboratories; unless they accept, are required to do so contractually (such as in some managed care programs), etc.
3. Definition of final destination (what we've refer to as “to claim” a TORTR unclaimed order) of eLabs in the TORTR is done by a licensed healthcare provider in the clinical laboratory chosen by the patient. For example, (a) the patient arrives at a clinical laboratory and tells the medical technologist (MT) that he/she has been ordered some tests from a doctor, (b) the MT goes into the TORTR through a gateway (web page, API, etc.) that allows MTs to query the TORTR for eLabs orders issued for patients and pending to be “claimed”, (c) the MT uses patient information and order-creator information to identify the eLabs order(s), (d) after the MT finds the eLabs order and determines that it can be fulfilled, the MT “claims” the eLabs to his/her clinical laboratory (present location) as consented by the patient. Once “claimed” the eLabs order message is introduced into in the appropriate B2B eLabs network (as if the ordering provider had selected a clinical laboratory in the first place) and the eLabs message is routed to the clinical laboratory/location where the patient selected to be served. Last but not least, the MT may also choose to use the TORTR to perform a “test performed notification” without having to incur in an additional eLabs transaction, by indicating in the TORTR that the eLabs has been “performed”; a capability most likely to achieve “test performed notification” at reduced costs to all involved.
4. Deferring definition of final destination (Point B) of eLabs is very accommodating if a patient doesn't know the name and/of address of his/her preferred clinical laboratory (common with the elderly who customarily depend on their “neighborhood clinical laboratories” for these services). Also, this may allow for scenarios such as the patient calling his/her preferred clinical laboratory to arrange an appointment, verify when is the best time to visit location due to low patient-load, so when the patient arrives the eLabs, his/her order has been “claimed”, and all supplies, labels etc. are ready to expedite fulfillment of the eLabs order.
5. eLabs handled through the TORTR gain an additional capability on top of allowing definition of eLab destination. If for any reason an eLabs order cannot be served by a clinical laboratory that initially “claimed” it, the clinical laboratory may return the eLab order it back to the TORTR so another clinical laboratory may “claim” it. In these cases there is a potential that if “test performed notifications” messages are sent back to the ordering provider through the TORTR, they may arrive from clinical laboratories the ordering provider wasn't expecting.
6. Some clinical laboratory test ordering-providers may adopt the habit of not defining final destination (Point B) of eLabs for any reason, including not to assume any responsibility of eLabs being routed to incorrect clinical laboratories.
7. Clinical laboratory ordering providers (a.k.a. “Point A”) may send eLabs orders to the TORTR for “temporary holding” prior to additional processing such as until some research and inquiries can be performed prior to determining the final destination (a.k.a. “Point B”) for the eLabs order; in essence the order's status would be that of an “Order-Undergoing-Inquiry-Before-Commit” (OUIBC), rather than an unclaimed order. For example, clinical laboratory test orders can be sent to the TORTR and a multicast of “inquires for information” (ex. testing capabilities, use of reference labs, pricing, wait-times, etc.) to various clinical laboratories (a.k.a. “possible” or “potential” Point B's). Then, once replies are received and evaluated, the most cost-effective and/or beneficial final destination can be defined so the eLabs order reaches the best possible fulfillment entity.
8. Any clinical laboratory tests “Results” are electronically returned to the requesting/ordering healthcare provider and the provider might receive results from various clinical laboratories in the event test where carried by more than one clinical laboratory entity.

Note that as with any medical orders, some electronic clinical lab orders might have differing activation and/or expiration dates depending on the urgency and/or use to be given to the test results. For example, a Cholesterol-level test might be postponed until one week before the patient's next appointment with the doctor so that results are as close as the next examination as possible; so if the next appointment is in one month, the cholesterol level tests might be given an active date of a week before the next doctor visit.

Also, some clinical laboratory test orders might never get to be “claimed” and might get purged from the system, but not without first notifying the ordering provider or doctor of such event since he/she might want to know which tests where never “claimed” as a way of determining patient compliance with health care and/or recommendations.

Alternatively, multiple orders for tests (ex. sequential Glycosylated Hemoglobin test) might be ordered in an escalated and/or periodic manner of dates to determine overall long term glucose level control of diabetic patients, hence the TORTR would accept and deliver the providers clinical laboratory test orders, following the dates specified allowing the provider to prepare various tests orders that will automatically become “new” and/or active as their activation date arrives and allow several orders to be placed in a virtual “queue” so they are sent to the destination clinical laboratory when their effective date arrives, automatically permitting the patient to visit his/her clinical laboratory of choice to be tested without having to re-visit or interrupt the provider. Additionally, any tests in the invention not “claimed” are notified to the healthcare provider prescriber giving the added benefit of informing the provider of patient's-compliance with follow-up and monitoring.

### Example of Electronic Imaging Diagnostic Studies (Radiology, Computer Tomography (CT), Magnetic Resonance Imaging (MRI), Positron Emission Tomography (PET), Sonography/Echography, Nuclear Medicine, etc.) with Embodiment of the TORTR/Invention

Implementing the TORTR to address electronic diagnostic imaging studies orders (eRadiology, eNuclear Medicine, eMRI, eCT-SCAN, etc.; and hereafter all encompassed under “eImaging”) can be viewed as a patient going to a healthcare provider that is licensed to request diagnostic tests and who considers that a imaging related diagnostic test is the best course of action to diagnose or rule-out a problem. In this case the patient is given a “medical order” to go to an Imaging Diagnostic Procedure and/or Test center or office; depending on the modality, possibly an X-Ray diagnostic-procedure/test provider, CT-Scan diagnostic-procedure/test provider, Nuclear Medicine diagnostic-procedure/test provider, Sonography center, etc., where “images” of the patient's body are attained and interpreted by highly-trained and qualified healthcare providers that understand the intricacies of the modality used, human anatomy, organ locations, densities and resulting image-contrasts. These images and interpretations are exchanged between the “ordering” and interpreting providers to establish or rule-out (discard) a patient complaint of health problem, health threats and/or determine a health related episode.

The provider that needs the support of a diagnostic-procedure/test to treat or diagnose the patient uses features similar to those available under the ePrescribing and eLabs models (to verify eligibility, insurance coverage, etc.) and can even be advised of complications such as allergies that might be important for performing or not some imaging diagnostic-procedures (as one example; such as the use of contrast material in radiological studies such as Iodine and having a patient allergic to crustaceans; which is very strongly related to Iodine allergic reactions, some of which can be deadly). The ordering doctor (Point A), after finalizing the eImaging order, “signs” and “submits” the order without defining a specific imaging diagnostic procedure/test provider (Point B or “destination”) for the electronic message/order or selecting TORTR as destination; which triggers the TORTR to intercept and/or capture the transaction for lacking destination information or because it was destined to the TORTR.

This allows for many advantages; amongst others (some out of scope of this brief description) and/or that might be identified at later include:
1. The patient may decide which eImaging services provider will produce and interpret his tests and/or procedures, without the ordering doctor's intervention or assistance, or may want to decide at a later time or place, thus the ordering doctor sends the eImaging order to the TORTR and “definition of final destination” is omitted by the ordering provider.
2. The TORTR prevents that patients be “directed” to a particular eImaging centers; unless they accept, are required contractually (such as in some managed care programs), or other reason.
3. Definition of “final destination” (what we've refer to as “to claim” a TORTR unclaimed order) of eImaging orders sent thought to the TORTR is done by a qualifier professional at the eImaging services provider center, office or location chosen by the patient. For example, (a) the patient arrives at an Imaging center and tells the attendant that he/she has been ordered some eImaging tests from a doctor, (b) the attendant (maybe a radiology technician or other managerial-level professional) goes into the TORTR through a gateway (web page, API, etc.) that allows the imaging center attendant to query the TORTR for eImaging orders issued for patients and pending to be “claimed”, (c) the attendant uses patient information and/or order-creator information to identify the eImaging order(s), (d) after the attendant finds the eImaging order and determines that it can be fulfilled, the eImaging order is “claimed” to the present imaging center, office or location as consented by the patient. Once “claimed” the eImaging order message is introduced into in the appropriate B2B eImaging network (as if the ordering provider had selected a imaging diagnostic-procedures/test services provider in the first place) and the eImaging order message is routed to the location where the patient selected to be served. Last but not least, the imaging center attendant (or other designated personnel) may also choose to use the TORTR to perform a “procedure/test performed notification” without having to incur in additional eImaging transaction, by indicating in the TORTR that the eImaging tests have been “performed”; a capability most likely to achieve “procedure/test performed notification” at reduced costs to all involved.
4. Deferring definition of final destination (Point B) of eImaging orders is very accommodating if a patient doesn't know the name and/of address of his/her preferred imaging diagnostic-procedure/test provider (such as it is more common with the elderly). Also, this may allow for scenarios such as the patient calling his/her preferred imaging center to arrange an appointment, verify when is the best time to visit the center/office due to low patient-load, so when the patient arrives the eImaging order has been “claimed” and the eImaging order fulfillment can be expedited.
5. eImaging orders handled through the TORTR gain an additional capability on top of allowing definition of eImaging destination. If for any reason an eImaging order cannot be served by a imaging procedures and/or tests provider that initially “claimed” it, the provider may return the eImaging order it back to the TORTR so another imaging services provider may “claim” it. Also, as before, “procedure/test performed notifications” messages are sent back to the eImaging-ordering provider through the TORTR, they may arrive from centers or imaging providers the ordering provider wasn't expecting.
6. Some eImaging ordering providers may adopt the habit of not defining final destination (Point B) of eImaging orders for any reason, including not to assume any responsibility of eImaging orders being routed to incorrect locations.
7. Imaging procedures/tests ordering providers (a.k.a. “Point A”) may send eImaging orders to the TORTR for “temporary holding” prior to additional processing such as until some research and inquiries can be performed prior to determining the final destination (a.k.a. “Point B”) for the eImaging order; in essence the order's status would be that of an “Order-Undergoing-Inquiry-Before-Commit” (OUIBC), rather than an unclaimed order. For example, eImaging orders can be sent to the TORTR and a multicast of “inquires for information” (ex. imaging testing capabilities, current patient load, equipment used and/or capabilities for the various imaging modalities, pricing, wait-times, interpreting provider credentials, etc.) to various imaging services providers (a.k.a. “possible” or “potential” Point B's). Then, once replies are received and evaluated, the most cost-effective and/or beneficial final destination (Point B) can be defined so the eImaging order reaches the best possible fulfillment entity.
8. Any Imaging Diagnostic Procedures/Test “Results” are electronically returned to the requesting/ordering healthcare provider and the provider might receive results from various imaging services providers in the event test where carried by more than one entity.

Note that as with any medical orders, some eImaging tests might have differing priorities and urgencies. For example, a Chest X-Ray and/or CT-Scan for a patient suspected of Cancer might need to be undertaken as rapidly as possible to intervene with the patient as soon as possible and improve his/her chances for survival. The invention can be used to prominently indicate the urgency the eImaging test has for the ordering provider.

Also, some eImaging test orders might never get to be “claimed” and might get purged from the system, not without first notifying the ordering provider or doctor of such event since he/she might want to know which tests where never “claimed” as a way of determining patient compliance with health care and/or recommendations.

### Example of Electronic Referrals/Consults and their Respective Results (Specialists, Sub-Specialists, Nutritionists, Skilled Nursing, Long-Term Care, etc.) with Embodiment of the TORTR/Invention

Implementing the TORTR to address electronic Referrals and/or Consults (eReferrals or eConsults.; hereafter used interchangeably) scenarios, can be viewed as a patient going to a healthcare provider (possibly the patient Primary-Care Provider or PCP) who in the process of providing his services either (a) wants a “second opinion”, (b) wants that a periodic or specialized service be performed to the patient to determine the degree and/or advancement of the patient's condition (one example being a yearly eye exam for diabetic patients), (c) wants to know how to care for a particular patient with a difficult to control condition (one example being consulting with an endocrinologist about a patient with a difficult to control diabetes or other hormonal condition), (d) who wants to consult al allied health professional such as a nutritionist (one example being to prepare a special diet for a patient with special dietary needs), or any other case or possibility where one healthcare provider wants to discuss and/or exchange information or ideas about a patient with a second (or more) healthcare provider(s) with specialized knowledge or areas of expertise in some particular area(s), in order to properly continue serving the patient.

The healthcare provider that needs a consult and/or perform a referral uses features similar to those available under the ePrescribing, eLabs and other electronic ordering models previously presented (to verify eligibility, coverage, etc.) to prepare an eReferral and/or eConsult (with relevant clinical information about the patient such as, but not limited to, a summary or the patients medical record, and the specific question(s) the ordering provider wants answered and/or attended) finalizes the eConsult or eReferral, “signs” and “submits” the order without defining and/or identifying a specific specialized provider as recipient (Point B or “final recipient”) for the electronic message/order, or selecting TORTR as destination; which triggers the TORTR to intercept and/or capture the transaction for lacking destination information or because it was destined to the TORTR.

This allows for many advantages; amongst others (some out of scope of this brief description) and/or that might be identified at later include:
1. The patient may decide which eReferral or eConsult provider to visit, without the ordering doctor's intervention or assistance, or may want to decide at a later time or place, thus the ordering doctor sends the eReferral/eConsult order to the TORTR and “definition of final destination” is omitted by the ordering provider.
2. The TORTR prevents, to a certain degree, that patients be “directed” to particular eReferral or eConsult providers; unless they accept, are required to do so contractually (such as in some managed care programs), or other reason.
3. Definition of “final destination” (what we've refer to as “to claim” a TORTR unclaimed order) of an eReferral or eConsult order sent thought to the TORTR is done by a qualifier professional at the center or office there the referred or consulted provider practices its trade. For example, (a) the patient arrives at an specialists office so he/she can attend the eReferral or eConsult and tells the attendant that he/she has been an eReferral or eConsult from a doctor, (b) the attendant goes into the TORTR through a gateway (web page, API, etc.) that allows the specialist provider attendant to query the TORTR for eReferrals and/or eConsults orders issued for patients and pending to be “claimed”, (c) the attendant uses patient information and/or order-creator information to identify the eReferrals or eConsults order(s), (d) after the attendant finds the order and determines that it can be fulfilled, the eReferral/eConsult order is “claimed” to the present location as consented by the patient. Once “claimed” the eReferral or eConsult order message is introduced into the appropriate B2B eReferrals or eConsults network (as if the ordering provider had selected a referent or consulting provider in the first place) and the eReferral and/or eConsult order message is routed to the location where the patient selected to be served. Last but not least, the attendant (or other designated personnel) may also choose to use the TORTR to perform a “referral/Consult performed notification” without having to incur in additional eReferral or eConsult transaction, by indicating in the TORTR that the eReferral or eConsult services “served”; a capability most likely to achieve “services performed notification” at reduced costs to all involved.
4. Deferring definition of final destination (Point B) of eReferrals and eConsults orders is very accommodating if a patient doesn't know the name and/of address of his/her preferred specialist provider (more common with the elderly). Also, this may allow for scenarios such as the patient calling his/her specialist to arrange an appointment, verify when is the best time to visit, so when the patient arrives the eReferral or eConsult order has been “claimed” and patient can be attended much quicker.
5. eReferrals and eConsults orders handled through the TORTR gain an additional capability on top of allowing definition of destination. If for any reason an eReferral or eConsult order cannot be served by a provider that initially “claimed” it, the provider may return the eReferral or eConsult order it back to the TORTR so another provider may “claim” it. Also, if “procedure/test performed notifications” messages are sent back to the eReferral or eConsult-ordering provider through the TORTR, they may arrive from providers the ordering provider wasn't expecting but helps the ordering provider understand his patient preferences. For example, if a specialist cannot fulfill an eReferral or eConsult order (ex. he/she is on vacation, out of his/her practice for whatever reason, etc.), the order can be sent back to the TORTR so another specialized provider can fulfill the patient's consult and/or referral.
6. Some eReferral or eConsult ordering providers may adopt the habit of not defining final destination (Point B) for eReferrals or eConsults orders for any reason, including not to assume any responsibility of orders being routed to incorrect locations.
7. Referral or Consultation ordering providers (a.k.a. “Point A”) may send eReferrals or eConsults orders to the TORTR for “temporary holding” prior to additional processing such as until some research and inquiries can be performed prior to determining the final destination (a.k.a. “Point B”) for the eReferral or eConsult; in essence the order's status would be that of an “Order-Undergoing-Inquiry-Before-Commit” (OUIBC), rather than an unclaimed order. For example, orders can be sent to the TORTR and a multicast of “inquires for information” (ex. experience with the condition that the patient is being consulted about, current patient load, wait-times and/or next appointment availability, provider credentials, etc.) to various providers (a.k.a. “possible” or “potential” Point B's). Then, once replies are received and evaluated, the most cost-effective and/or beneficial final destination (Point B) can be defined so eReferral or eConsult order reaches the best possible provider.
8. All eReferral and/or eConsult “results” (replies with recommendations, treatment options or changes, of discussion between healthcare provider's serving the patient about the patient's condition(s), are electronically returned to the requesting/ordering healthcare provider. The provider might receive results from various referral and/or consulting providers in the event some referrals and/or consults where carried out by one or more specialized providers. Also, results might arrive from a specialized provider that was not the one discussed between the ordering provider and the patient during their encounter(s) as the patient might have change his/her mind and visited a different specialized provider than the one discussed.

Note that as with many medical orders, some eReferrals and/or eConsults might have differing priorities and urgencies. For example, an uncontrolled diabetic patient might need to be attended urgently to try to control his blood sugar levels as quickly as possible to improve his/her condition and quality of life. The invention can be used to prominently indicate the urgency the eReferral and/or eConsult.

Also, some eReferral and/or eConsult orders might never get to be “claimed” and might get purged from the system, not without first notifying the ordering provider or doctor of such event since he/she might want to know which orders where never “claimed” as a way of determining patient compliance with health care recommendations, treatment follow-up and/or maintenance.

### Example of Electronic Appointment Requests with Embodiment of the TORTR/Invention

Implementing the TORTR it in an electronic Appointments scenario might look something like a patient going to a healthcare provider (or institution) who in the process of providing services either (a) wants to refer the patient to another professional (or institution), (b) or the patient wants to see the availability/time-slots available for an appointment with another healthcare provider (as suggested by a first healthcare provider, or because the patient wants a second-opinion, or for any other reason . . . ) in order accelerate or simplify the assignment of an appointment for the patient.

In the case where one healthcare provider wants to refer and/or send the patient to another provider, the implementation works much like the eReferrals embodiment previously presented extended with the addition that available time-slots/appointment-availabilities, etc., made available and presented to the referring provider through the TORTR as it holds copies of other provider's time-slot/appointment availabilities; hence an appointment with another provider can be expedited by acquiring the appointment at the point of care. The healthcare provider who wants to arrange a referral appointment uses the TORTR (and may verify eligibility, insurance coverage, etc. if desired), look at appropriate providers who publish make their appointment availabilities electronically (either through the TORTR, or through interfaces from their existing interoperable electronic appointment solutions or services and the TORTR in order to consolidate appointment availabilities and views at a single point of contact), the provider identifies the most appropriate appointment availability and request that such availability be assigned to the patient on the patient's behalf.

In another scenario, a patient is seeking to make an appointment at the most convenient time for him/her, sees appointment availabilities published to patients through the TORTR (arriving at the TORTR either because providers enter their available times in the TORTR directly or through interfaces from their electronic appointment or practice management systems with the TORTR). Then, once a patient identifies a space or time-slot that is convenient, they may request that a particular available space be assigned to him/her. In either case, the TORTR serves to normalize the electronic appointments availability presentation/publishing of various providers how wish to provide electronic appointment scheduling in their practices so patients can arrange appointments through a single and intuitive interface.

Electronic appointment requests and/or assignments will be electronically transmitted and consolidated using existing healthcare accepted electronic data interchange (EDI) standards with referrals and scheduling capabilities (such as HL7 scheduling messages, amongst others) or using more horizontal standards available over the Internet such as vCal, iCalendar (RFC 2445, RFC 2446, RFC 2447), RSS, and/or other standards that can be used to “publish” the equivalent of an electronic “appointment-book” and its availabilities, electronically receive requests to assign an availability to a particular individual, electronically confirm an appointment assignment and/or adjudication, and/or electronically notify a denial of the request for a particular appointment for any reason (examples being two or more people who requested the same time-slot, and the first message/person whose message arrived was adjudicated the space, or the provider blocking a series of previously available time-slots for any reason but the blockage was not replicated in-time though the systems giving the impression that the slots where still open for adjudication).

In the case that one provider arranges an appointment on a patient's behalf, since the process may simulate eReferrals, but the ordering-provider may include (at his/her discretion) relevant clinical information about the patient that might help the “receiving” or “second” provider understand the patient and concerns quicker and help expedite services (time spent interviewing the patients to collect conditions and/or relevant medical history can be reduced.)

This allows for many advantages; amongst others (some out of scope of this brief description) and/or that might be identified at later include:
1. Electronic appointments capabilities do NOT invalidate nor eliminate regular or customary visits to a provider's office, or making phone calls, to request an appointment; regardless of the invention.
2. Patient may be referred/facilitated an appointment by their current provider, which eliminates one more responsibility for the patient and expedites his/her healthcare services and quality of care.
3. Appointments made on behalf of patients may include clinical information about the patient so the “receiving” provider can expedite its services to the patient.
4. Patients may retain the decision-making process and decide with which provider they wish to make an appointment with without feeling “directed”; unless they accept recommendations from their primary care providers, are required to arrange appointments with particular of limited number of providers as a result of the “network of providers” available under his/her insurance coverage (such as in some managed care programs), or other reason.
5. If a provider with whom an appointment was arranged through the TORTR cannot fulfill the appointment, the appointment can be re-scheduled, cancelled and/or a new appointment arranged (either with the same or different provider).
6. If a patient doesn't know the name of address of the provider with whom he/she usually consults or visits (such as it more common with the elderly) and needs to make an appointment, deferring final appointment request destination through the use of the TORTR may allow the patient to search for the required information or make phone calls to their customary providers so that the eAppointment can be “claimed” by the appropriate provider.
7. Any appointment “Results” that could be shared back with the initial provider (if the provider was the one who arranged the appointment on the patient's behalf and/or the patient requests that the original physician be kept informed about the findings and/or conclusions of the appointment) in electronic form to the “original” provider using the same eReferrals “Results” capability of the TORTR.
8. Some providers might develop the custom of “ordering appointments” to other providers with special qualifications, but might may adopt the habit of not defining final destination (Point B) for the eAppointment-requests/orders for any reason, including not to assume any responsibility of orders being routed to incorrect locations.
9. A patient might contact a provider with whom he wants an appointment, and if an eAppointment “order” without destination is present in the TORTR, the appointment order could be “claimed” to the patient's selected provider. Then, once the patient is attended by the second provider, the first provider may receive a notification of the encounter; a marvelous way of keeping primary care providers informed about patient compliance with instructions and/or recommendations.
10. Appointment requests issued from providers on patient's behalf (a.k.a. “Point A”) may be sent to the TORTR for “temporary holding” prior to additional processing such as until some research and inquiries can be performed prior to determining the final destination (a.k.a. “Point B”) for the eAppointment request; in essence the order's status would be that of an “Order-Undergoing-Inquiry-Before-Commit” (OUIBC), rather than an unclaimed order. For example, orders can be sent to the TORTR and a multicast of “inquires for information” (ex. experience with patient's current signs, symptoms, and/or condition, current patient load, wait-times and/or next appointment availability, etc.) to various providers (a.k.a. “possible” or “potential” Point B's). Then, once replies are received and evaluated, the most cost-effective and/or beneficial final destination (Point B) can be defined so eAppointment reaches the best possible provider.
11. Definition of eAppointment request destination (what we've refer to as “to claim” a TORTR unclaimed order) sent thought to the TORTR is done by a qualifier professional at the center or office where the provider with whom the appointment was made practices its trade. For example, (a) the patient arrives at providers office and request that an eAppointment request be “claimed” to get an appointment with the provider that the patient is visiting at the time, (b) the attendant uses patient information and/or order-creator information to identify the eAppointment request order(s), (c) after the attendant finds the eAppointment order and determines that it can be fulfilled, eAppointment order is “claimed” to the present location as consented by the patient's presence. Once “claimed” the eAppointment order message is introduced into the appropriate B2B eAppointments network (as if the ordering provider had selected a provider with whom the patient should have an appointment in the first place) and the eAppointment order message is routed to the location where the patient selected to be served. Last but not least, the attendant (or other designated personnel) may also choose to use the TORTR to perform an “appointment performed notification” without having to incur in additional eAppointment transaction, by indicating in the TORTR that the eAppointment services where fulfilled (served)); a capability not available at the time unless the patient notifies the ordering provider of his attending the appointment or the other provider contacts the ordering provider to notify him/her that the appointment was fulfilled using traditional methods such as conversations and/or phone calls.

Note that as with many medical orders, some appointments might have differing priorities and urgencies. For example, a difficult to control diabetic patients might need to be attended urgently by an endocrinologist as quickly as possible. The TORTR can be used to prominently indicate the urgency the appointment.

Also, some appointments might never get undertaken and/or “claimed” from the TORTR (if sent as “appointment orders”) might get purged from the system, not without first notifying the ordering provider or doctor of such event since he/she might want to know which appointments where never “claimed” as a way of determining patient compliance with recommendations, follow-up and/or self-involvement in their own care.

1. A method of routing electronic orders without defining the destination, the method comprising the steps of:
a. Trapping, intercepting and capturing an order without specific destination address;
b. Storing the order in a repository;
c. Allowing the repository to be searched or queried for orders
d. Receiving and/or accepting a “claim” for the order; and
e. Releasing the order to the destination to whom is was “claimed”.

2. The method of claim 1, wherein the order is a medical order.

3. The method of claim 1 further comprising: wherein the order is routed after a “claim” for the order is received.

4. The method of claim 1 further comprising: wherein the step of routing the order is performed in response to the step of receiving a “claim” for the order.

5. The method of claim 2, wherein the order is:
a. a prescription
b. a petition or order for clinical laboratory tests
c. a petition or order for a radiation-based study or service
d. a petition or order for a electromagnetic-based study or service
e. a petition or order for a sound-based study or service
f. a petition or order for a light-based study or service
g. a petition or order for a temperature-based study or service
h. a petition or order for a study or service involving a foreign substance to a patients body
i. a petition or order for a study or service involving a foreign object on a patients body
j. a petition or order for a consultation to a health professional
k. a petition or order for a referral to a health professional
I. a petition or order for an appointment with a health professional
m. any combination of the aforementioned
n. a petition or order for products or services on behalf of a patient

6. The method of claim 5, wherein the order is issued through the exchange of an electronic message containing the order.

7. The method of claim 1 further comprising: wherein the order is routed depending on information contained in the “claim” which indicates where to route the order to.

8. A system for electronic medical order communication and routing comprising:
a. a processing element;
b. a communication network;
c. storage;
d. a repository for storing an order;
e. a “claim” receiver; and
f. an order router.

9. The system of claim 8, wherein the repository stores orders.

10. The system of claim 9, wherein the stored order is a medical order.

11. The system of claim 9 further comprising: wherein the order router routes the order from the repository after a “claim” for the order is received via the “claim” receiver.

12. The system of claim 9 further comprising: wherein the order router routes the order from the repository in response to a “claim” received via the “claim” receiver.

13. The system of claim 10, wherein the order is:
a. a prescription
b. a petition or order for clinical laboratory tests
c. a petition or order for a radiation-based study or service
d. a petition or order for a electromagnetic-based study or service
e. a petition or order for a sound-based study or service
f. a petition or order for a light-based study or service
g. a petition or order for a temperature-based study or service
h. a petition or order for a study or service involving a foreign substance to a patients body
i. a petition or order for a study or service involving a foreign object on a patients body
j. a petition or order for a consultation to a health professional
k. a petition or order for a referral to a health professional
l. a petition or order for an appointment with a health professional
m. any combination of the aforementioned
n. a petition or order for products or services on behalf of a patient

14. The system of claim 13, wherein the order is an electronic order.

15. The system of claim 12 further comprising: wherein the order is routed depending on information contained in the “claim” which indicates where to route the order to.

16. A computer-readable medium having computer-executable instructions for performing a method comprising:
a. receiving an order;
b. storing the order in a repository;
c. receiving a “claim” for the order; and
d. routing the order.
